(19) United States
(12) Patent Application Publication
(10) Pub. No.: US 2006/0242306 A1
(43) Pub. Date: Oct. 26, 2006

(54) Child-oriented computing facilities

(76) Inventors: Clifford T. Boro, Port Saint Lucie, FL (US); Thomas Broadhead, San Diego, CA (US)

Correspondence Address: STRATEGIC PATENTS P.C.., C/O PORTFOLIOIP, P.O. BOX 52050, MINNEAPOLIS, MN, 55402, US

(21) Appl. No.: 11/385,982

(22) Filed: Mar. 20, 2006

Related U.S. Application Data
(60) Provisional application No. 60/742,976, filed on Dec. 6, 2005.
(60) Provisional application No. 60/663,215, filed on Mar. 18, 2005.

(51) Int. Cl. G06F 15/16

(52) U.S. Cl. 709/227

(57) ABSTRACT

An aspect of the present invention relates to methods and systems for providing a child-oriented computing system.

### RELATED APPLICATIONS

This application claims the benefit of U.S. App. No. 60/663,215, filed Mar. 18, 2005 and U.S. App. No. 60/742,976, filed on Dec. 6, 2005. The entire contents of these applications is incorporated herein by reference.

### FIELD OF THE INVENTION

This invention relates to methods and systems involving providing a child-oriented computing system, and more particularly, embodiments of the present invention relate to software systems adapted to facilitate child-oriented computing activities.

### BACKGROUND OF THE INVENTION

It is well known that personal computing devices, when used in conjunction with the Internet, provide vast opportunities for learning, entertainment, communication, receiving timely information, accessing electronic/informational services, and so forth. It seems that everyone, from schoolchildren through elderly people, is increasingly using personal computing devices in the course of their daily activities, for work and for pleasure. This trend seems destined to continue into the foreseeable future.

Increasingly, children use personal computing devices to keep track of their schedules, check the weather, play games, communicate with friends and parents, complete homework assignments, learn new things, and so forth. This increased use of personal computing devices by children creates a challenge for parents, who may wish to monitor or filter the information to which a child has access. Moreover, a parent may determine that a child should spend more time using a personal computing device for one thing (such as doing homework) and less time using it for other things (such as playing games). Unfortunately, a modern personal computing device typically does not provide a parent with the controls that would allow him to define a policy relating to how a child may use the personal computing device.

More generally, most personal computing devices are directed at and best operated by adults. The hardware is typically sensitive to environmental conditions—cell phones fail when dropped in water, DVDs fail when scratched, and so forth. The software is typically loaded with features that, even when they work as advertised, are often hard to learn, explain, understand, or fully utilize. To illustrate this, consider some of the actions that are associated with clicking a mouse button in the Windows XP operating system: Rapidly double-left-clicking an icon may open the object associated with the icon or it may pull up a menu of options from which the user is supposed to select an application that should open the object. However, slowly double-left-clicking the icon may cause the name of the icon to be placed in an edit mode. Right clicking the icon may cause a menu of options to appear. Clearly, the designers of these personal computing devices assume that the users of the devices will bring a certain degree of care and cognition to the task of using the devices.

Unfortunately, it is not safe to assume that a child can provide the level of care or cognition required to effectively operate most personal computing devices. There remains a need for personal computing devices that are directed at children and that are associated with appropriate parental controls and oversight tools and techniques.

### SUMMARY OF THE INVENTION

Described herein are systems and methods for providing a child-oriented computing system.

In embodiments, the methods and systems disclosed herein include a combination system that includes a PC, TV, DVD Player and Personal Video Recorder designed for children. The system may use an operating system (e.g. Linux operating system, Window's operating system) with a graphical user interface designed to enable common tasks performed by kids, such as doing homework, playing games, and communicating with other kids. The system may be preloaded with games and homework tools, as well as ability to watch DVDs and TV (and record programs). The system may include communication software, such as email and instant messenger applications. The system may be provided with a form factor designed for children.

In embodiments the methods and systems may be provided with parental controls, such as controls that control the content that children can access (whether on television, websites, games, or the like), controls that restrict when children can access what content, and controls based on events (such as allowing access to games or television when homework is complete). Controls can be exercised by and/or shared with others, such as teachers, tutors, caregivers, or the like.

Methods and systems disclosed herein can include a subscription service that allows parents to modify controls through, for example, a remote network interface, such as a Web interface. Through the networks parents can help children keep schedules, such as waking them up, letting them know how to dress (such as based on the weather as determined through the web), sending timed messages about homework, sending photographs or video, or the like. In embodiments, the parental controls may provide control over the time when the applications on the computing system are available to the child. For example, a parent may set the controls to allow the child to watch television, video, or a DVD between certain hours in the day, while other activities such as word processing, spreadsheet software and the like may be offered during other periods including overlapping periods.

In embodiments, the child-oriented computing system may provide parental control over a child's use of the computing facility, wherein the control may be administered locally at the computing facility or remotely from an administrative computing facility. In embodiments the remote parental controls allow parents to set, reset, and modify parental controls, to integrate and send movies (such as home movies), to set calendar events, to send messages and the like, to transmit calendars items and messages from their Web site to the computing facility.

In embodiments the user interface and content for the system may be adaptive and may change automatically, with user triggers, based on events, such as the age of a child or the user interface and content may change based on another parameter. For example, as a child celebrates a birthday or the child achieves a certain level of competence, the device may make available new applications, such as instant messenger, or access to age-appropriate games and contents. Also, the content of applications may become more sophisticated and robust, such as offering other buttons and controls that are hidden for younger children.

In embodiments the user interface and/or content may change based on the user demonstrating proficiency, such as adding more functions of an application or presenting new applications when a child demonstrates mastery of a particular task. For example, if a child shows the ability to open and view photos, applications for editing and sending photos may be presented, and the like.

In embodiments, the user interface for the system may include characters that are designed to walk children through common tasks such as learning new applications.

In embodiments, the user interface may provide an access control feature, which may present a child with a number of pictorial challenges in lieu of requiring the child to enter a password to gain access to the system.

In embodiments the device may include the capability to be provided with a personalized or customized exterior, such as with printable slide in panels that allow a user to change the “skin” of the device cheaply and conveniently. In embodiments the “skins” can be silk screened for convenient interchanging of styles and colors.

In embodiments the cable connections come out of the top of the device, for easier access by users (and permitting the device to be placed against a wall without rear access). In embodiments the user interface includes an LCD screen.

In embodiments, one part of the child-oriented computing system is a computing facility, such as a COTS PC. This computing facility may be operatively coupled to the Internet and, through the Internet, to an external facility. The computing facility may be designed for use by a child, who may be a user of the computing facility.

In embodiments, the computing facility may consist of parts and part combinations that provide a curved, recessed, raised, painted, or other appearance, which may be directed at being attractive to a child. The parts and part combinations may also be designed to shed liquids away from electrical parts, should liquids be spilled on the computing facility. The parts and part combinations may provide a pivot or tilt that provides an improved viewing angle with respect to a monitor of the computing facility and a user of the computing facility.

In embodiments, digital content may be built into the computing facility as a standard feature, or it may be downloaded via the Internet; retrieved from a physical medium, such as a CD, DVD; created at the computing facility by a user of the computing facility; and so forth.

In embodiments, the computing facility may provide increased reliability as compared with analogous facilities directed at adults. In one embodiment, this increased reliability is provided by computing facility's automatic storage of digital content from a physical medium into a local storage facility of the computing facility.

In embodiments, the computing facility provides a service, which may comprise a media aspect and a non-media aspect. The media aspect may be associated with a media facility, which may be an audiovisual facility, an audio facility, an image facility, a Web facility, an interactive program facility, a messaging facility, and a help facility. All of these facilities may be associated with digital content and may provide a rendition of the digital content to the user of the computing facility.

Various embodiments of the child-oriented computing system are provided with an administrative server application and an administrative software component provided locally at the computing facility and/or remotely at an external facility or an administrative computing facility, respectively. Some of these embodiments provide parental controls that are only locally accessible at the computing facility. Others of these embodiments provide only remotely accessible parental controls that are not accessible at the computing facility. Still others of the embodiments provide a mix of local and remote parental control.

In embodiments, the child-oriented computing system may provide a parental community that may enable parents to communicate with each other.

In embodiments, the computing facility may provide different user interfaces that vary in complexity and capability, perhaps as a function of the age and/or skill level of a user.

In embodiments, a parent may have access to a support button, which may provide an authorization to log and transmit current system information to an external facility, perhaps in association with or during a call to technical support.

### BRIEF DESCRIPTION OF THE DRAWINGS

The foregoing and other objects and advantages of the invention will be appreciated more fully from the following further description thereof, with reference to the accompanying drawings wherein:

FIG. 1 is a hardware block diagram of an embodiment of a computing facility.

FIG. 2 is a perspective view of an embodiment of a computing facility.

FIG. 3 is a perspective view of an embodiment of a computing facility.

FIG. 4 depicts a physical medium containing digital content and a medium feature.

FIG. 5 is a functional block diagram of an embodiment of a computing facility providing a service.

FIG. 6 depicts an embodiment of a child-oriented computing system.

FIG. 7 depicts an embodiment of a child-oriented computing system.

FIG. 8 depicts an embodiment of a child-oriented computing system.

FIG. 9 depicts an embodiment of a child-oriented computing system.

FIG. 10 depicts an embodiment of a child-oriented computing system.

FIG. 11 depicts an embodiment of a child-oriented computing system.

FIG. 12 depicts an embodiment of a child-oriented computing system.

FIG. 13 depicts an embodiment of a child-oriented computing system.

FIG. 14 depicts an embodiment of a child-oriented computing system.

FIG. 15 is a screenshot of a user interface provided by an administrative software component.

FIG. 16 depicts a functional block diagram of a computing facility.

FIG. 17 depicts a graphical user interface.

FIG. 18 is a logical flow diagram of a process for accepting a secret or solution.

FIG. 19 is a logical flow diagram of a process for verifying that a user knows a secret or solution.

### DETAILED DESCRITPION OF THE INVENTION

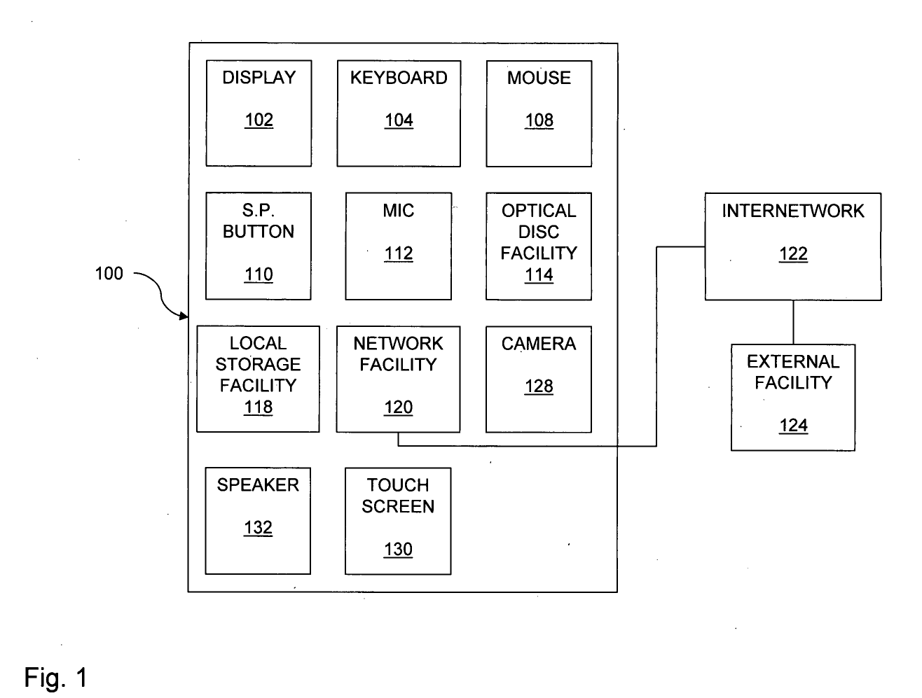

Referring to FIG. 1, in some embodiments, a child-oriented computing facility 100 may comprise a commercial, off-the-shelf (COTS) computing facility, such as and without limitation a personal computer (PC), a cell phone, a Sony PSP2, and the like. The COTS computing facility may run an operating system such as Linux or a variant thereof, a Microsoft Windows-brand operating system, Mac OS X, and so forth. In the preferred embodiment, the computing facility 100 may comprise a COTS PC.

In embodiments, the computing facility 100 according to the principles of the present invention may comprise the following elements: a display 102; a keyboard 104; a mouse 108; a special-purpose button 110; a microphone 112; a optical disc facility 114; a local storage facility 118; a network facility 120; a camera 128; a touch screen 130; a speaker 132; and so forth. The computing facility may be operatively coupled to an internetwork 122, such as the Internet. The internetwork 122 may, in turn, be operatively coupled to an external facility 124, which is described in detail hereinafter in reference to other figures.

In embodiments, the internal components of the computing facility 100 may include a primary motherboard. The motherboard may include a central processing unit (CPU); RAM memory (which may be the local storage facility 118), such as a RIMM chip, SRAM, DRAM, a BIOS chip; a PCI slot; an Accelerated Graphics Port; a ZIF socket; a disk controller, which may be directed at controlling a hard drive or floppy drive; an additional chipset; an expansion slot; a parallel port; a PS/2 port; a serial port; an ATX power connector; a fan; a battery; and so forth. The motherboard may be connected to an external power supply in order to receive power from a standard wall electrical outlet. Additional internal components may include a media drive (of which the optical disc facility 114 may be comprised) and/or ports, such as and without limitation a compact disc player/recorder, a digital video disc player/recorder, removable disk drives (e.g. a USB jump drive, memory card or the like). The internal components may connect with multimedia components, such as an audio speaker and/or the display 102 (which may comprise an LCD, plasma, CRT, LED, holographic, or other monitor or display device).

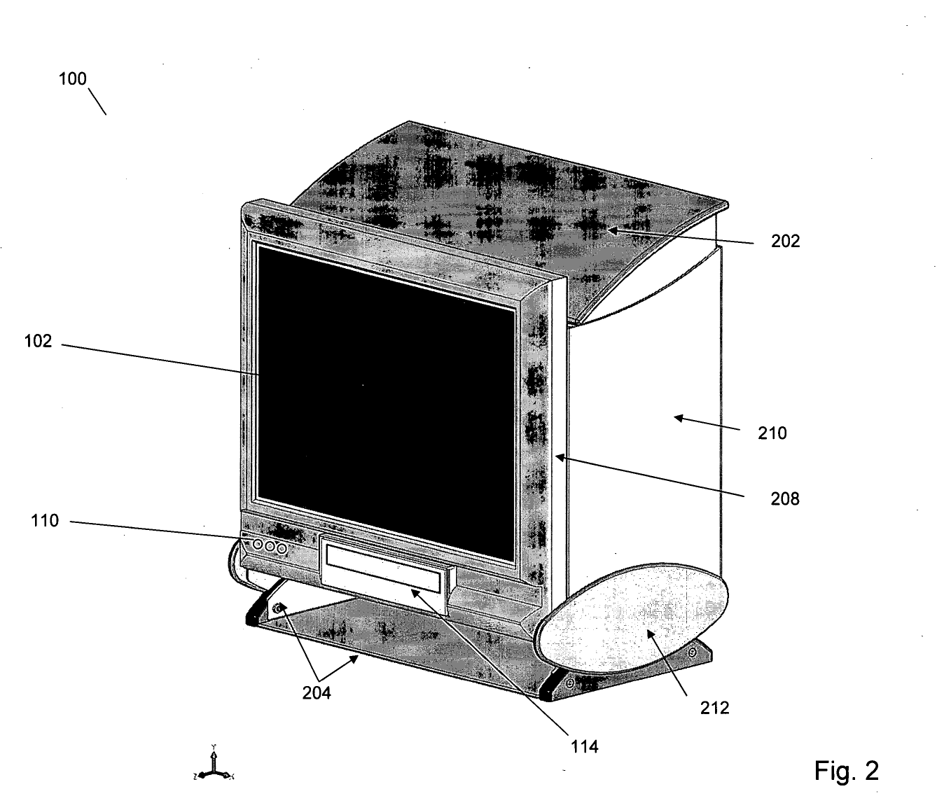

Referring to FIG. 2, one of many possible embodiments of the computing facility 100 may consist of parts and part combinations selected from the group of a top cover 202, a tilt base and keyboard home 204, a monitor front bezel and overall front covers 208, two side panels 210 (due to the perspective of the figure, only one is shown), and two oval panels 212 (again, due to the perspective of the figure, only one is shown). The computing facility 100 may be constructed from a number of parts and or a single formed piece. The computing facility 100 may be shaped with compound curves, arcs, cutouts, recessed areas, raised areas, and the like. The computing facility 100 may be decorated with color and or design. For example, the raw materials for the parts may be pigmented and or painted. The computing facility 100 may have designs that are formed into the material (e.g., by relief designs or raising the material), painted onto the material and/or applied to the material. The top cover 202 may be designed in a shape that sheds liquids away from electrical parts that are vulnerable to liquids. For example, a “spill-proof” design may include a top cover 202 with a plane that is curved such that a spilled liquid will be forced by gravity to follow the curved plane away from the internal components, rather than seeping straight down into the computing facility 100.

In embodiments the computing facility 100 may comprise arcs formed into each side wall, extending below the base of the computing facility 100. These curve extensions may fit into the tilt base 204. The tilt base 204 may be used to adjust the viewing angle of the display 102. In conjunction with the curved lower portion of the side panels 210, the tilt base 204 may permit the monitor 102 to rotate forwards and backwards on an axis running parallel to the plane of the monitor 102. This may allow the overall enclosure (that is, the computing facility excluding the tilt base 204) to tilt frontward and backward, which may improve a viewing angle with respect to the monitor 102 and a user of the computing facility 100. The pivot point may be approximately at the center of gravity of the computing facility 100. The sides of the computing facility 100 may be constructed of sheet metal for improved cost efficiency, and structural soundness. The tilt base 204 may be either two independent parts, one on the right and left, or one continuous part with a tilt feature. The continuous part may have provisions to store a keyboard and may also hold the mouse 108 and/or remote control (which may comprise the special-purpose button 110).

In embodiments the face of the DVD player/recorder 114 may be positioned so that it is on the same side of the computing facility 100 as the monitor screen 102. The DVD player/recorder 114 may be placed within the computing facility 100 so that it is directly beneath the lower edge of the monitor 102, with the body of the DVD player/recorder 114 positioned perpendicular to the monitor screen 102.

In embodiments, the top panel 202 may be curved to provide a deterrent to setting objects on the computing facility. The top panel 202 may be translucent, transparent, or opaque. The top panel 202 may be lighted for a decorative effect. Air gaps placed in the back, bottom, and/or sides of the computing facility 100 are provided to permit greater air circulation inside the computing facility.

In embodiments a power supply for the computing facility may face the same side as the motherboard. The power supply may be an external power supply or an internal power supply.

In embodiments, a design, form factor, and/or configuration of the computing facility 100 may allow for changing the external panels 202, 210, 212. For example, there may be left, right, back, and/or top interchangeable “skins,” plus oval shaped parts on the left and right side of the computing facility 100. The external skins may be decorative through the use of pigment, paint, embossing, shaping, relief or raised areas, stickers, silk screening, and the like. The external skins, panels, or other such external physical components may be capable of changing without the use of tools. For example, the panels may snap on or have some other type of non-tool required fastening system (e.g. through the use of clips, pressure fittings, and the like). The use of flat panels in the design may allow for low cost printing. The panels may also be clear and allow for placing photos behind them. Flat panels may lower the cost of shipping the computing facility, as they may be packed for shipment in an unassembled state thereby reducing the volume of the shipment. The decorative panels may be thin (e.g. a film or wall paper-type material). In sum, this design may allow a user of the computing facility to easily change its appearance.

In embodiments, the front panel 208 of the computing facility 100 may be designed to hold the computing facility's power and feature controls, of which the special-purpose button 110 may be comprised. Controls may include a power on-off switch, a sleep mode switch that enables a user to turn off major power consuming functions during periods of inactivity, a TV mode to open a TV function, a volume control, TV channel function, a processing facility, digital video recorder functions (e.g. play, stop, pause etc.), and the like. These controls and features may be located on the front panel 208 and/or in other locations, such as on a remote control or other part of the computing facility 100. The front panel 208 may be designed to change easily by slipping a decorative panel on over the front.

In embodiments, a sound system may be associated with the computing facility 100. The sound system may comprise the speakers 132, which may be placed inside the computing facility 100. These internal audio speakers 132 may be placed facing the user on the front panel 208 of the computing facility 100. Alternatively, the sound system may comprise a jack to which external audio speakers may be connected. The opening of this jack may be disposed anywhere on the computing facility 100.

In embodiments, the footprint of the computing facility 100 may be minimized based at least in part on the use of a small sized motherboard. This may allow for the footprint to be similar in size to a conventional desktop personal computer with a CRT monitor. The design may provide additional space saving based at least in part on the computing facility 100 combining the functions of a television, digital video recorder, and computer. The design of the computing facility 100 may minimize the number of individual parts required by combining features. For example, the use of a CRT monitor in this combination may appear like a television screen or typical CRT layout, however, this configuration compacts the components behind the monitor to make efficient use of the space. The design may use fewer parts than a typical computer monitor chassis and monitor and may, therefore, have a cost advantage over separate components.

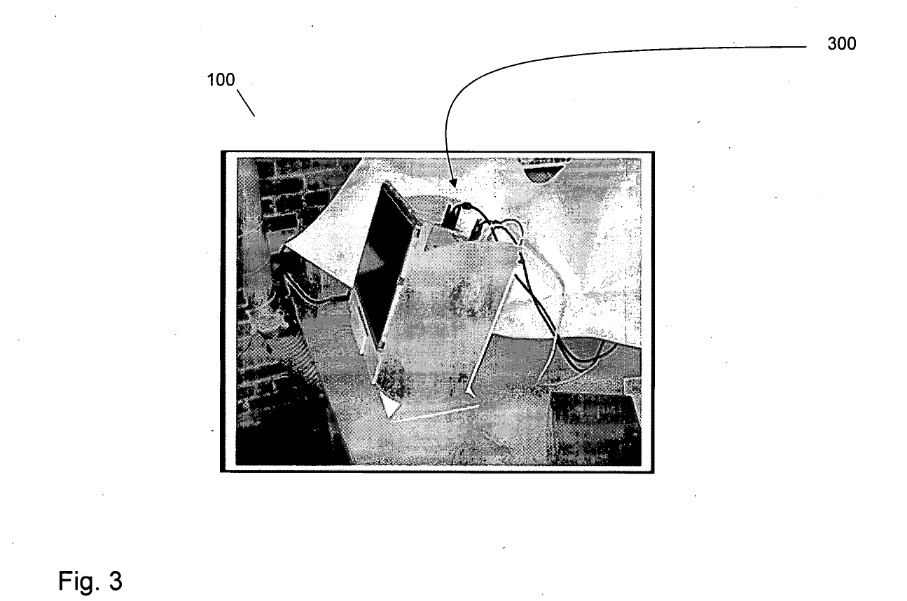

Referring now to FIG. 3, in embodiments, the primary PC motherboard may be vertically positioned so that the external connectors 300 (e.g., USB ports) are facing upwards. Vertical positioning of the motherboard may allow for efficient cooling by enabling the heated air rising from the motherboard to be more quickly evacuated from the computing facility 100. The spill-proof, curved top panel 202 may be hinged so that it may be opened for access to the internal components of the machine. The hinge may have a pivot point on the back side of the computing facility, opposite the monitor screen. As depicted, the top panel 202 may also be capable of being removed from the computing facility entirely.

In embodiments, the hardware design of the computing facility 100 may save space by providing the functionality of multiple devices within a single compact device. A child's room may be cramped with space at a premium. The hardware design of the computing facility 100 may save space based at least in part on providing a multiple purpose computing facility with a width, height and depth of a typical CRT monitor and its stand. The keyboard may fit in a space beneath the DVD/CD combination drive 114 and space may be provided to store a remote control and a mouse when not in use. The cables used by the computing facility may exit from the top of the computing facility 100, enabling the computing facility to be placed flush against a wall. The weight of the computing facility 100 may enable easy movement of the computing facility between rooms.

In embodiments, the computing facility 100 may be designed for simplicity of physical setup. For example, the computing facility 100 may be shipped with the keyboard 104 and mouse 108 connected. The setup of cables for the computing facility 100 may be reduced to only the power cable, television cable, and internet cable. The computing facility 100 may ship with a clearly labeled cable splitter, television cable and Ethernet cable already connected to the unit for easy setup. The reduction of cables required by the computing facility 100 may be obtained based at least in part on the computing facility's built-in 15 inch monitor 102, eliminating the need for a separate monitor cable and monitor power cable. Additionally, the computing facility 100 may have built in speakers 132, eliminating the need for cables between speakers, a speaker power cable and a cable from the speakers to the computer chassis. The computing facility 100 may have a built in infrared receiver for a remote control, thereby eliminating the need for a separate cable extending to a TV Tuner card.

In embodiments, the computing facility 100 may be ergonomically designed to address the special computing needs of children and safeguards required. The computing facility 100 may have a spill proof keyboard, with a layout and key sizes that are appropriate for kids in a target age group. The computing facility 100 may provide a mouse 108 that is appropriately sized for the hands of children. The computing facility 100 may provide a slot-loading CD-R/CD-RW/DVD-ROM drive 114 to prevent tray breakage that can occur with non-slot-loading drives. The computing facility 100 may enable kids to match the aesthetics of a computing facility to their preferences, by providing the ability to replace panels 202, 210, 212 on the exterior of the computing facility 100.

Referring now to the present invention in general terms, an objective of the present invention may be to provide parental control over a child's access to digital content. The parental control may be provided remotely, with the parent at a separate location from the child. The parental control may be provided locally. Additionally or alternatively, the parental control may be provided asynchronously, with the parent specifying a control at one time and the child being subject to the control at another time.

Referring now to FIG. 4, the digital content 402 may comprise a digital representation of one or more of the following, any of which may or may not be protected by digital rights management: a movie, a song, a multimedia presentation, a Macromedia Flash file, a sound clip, a text message, a blog post, a picture, an avatar, a comment, a calendar, an event reminder, an icon, a signal, an instant message, a file, or any other content.

The digital content 402 may be contained in a physical medium 400. This medium 400 may comprise any medium capable of storing and/or transmitting the digital content 402. Thus, the medium 400 may without limitation comprise, RAM, a DVD disc, a CD, an HD-DVD disc, a Blu-ray disc, a data network connection such as may be associated with the Internet (such as and without limitation comprising a physical layer, a data-link layer, a transport layer, and/or an application layer), a Firewire connection, an S-Video connection, a USB connection, a SCSI connection, a memory stick, a USB key, a dongle, Flash memory device, and so forth.

The physical medium 400 may comprise a medium feature 404. In some embodiments, the medium feature 404 may comprise an intentional design feature, such as and without limitation a form factor, a computer storage density, a pit depth, a magnetic property, an optical property, a power requirement, a physical interface, and so forth. In other embodiments, the medium feature 404 may comprise an unintentional feature, which may be deleterious to the performance of the physical medium 400, such as and without limitation a manufacturing defect, a design defect, a scratch (such as on an optical disc), and so forth. In some cases, a user may provide the medium feature 404. In one example of particular relevance, the physical medium 400 may be an optical disc and the user may be a child. In this example, the child may intentionally or unintentionally introduce a scratch to the optical disc. This scratch may be a medium feature 404. It will be appreciated that the scratch may cause a degradation of performance of the optical disc. This degradation of performance may without limitation comprise a reduced read speed, a reduce write speed, a prevention of access to parts of the digital content 402, a prevention of access to all of the digital content 402, and so forth. Many other such examples will be apparent.

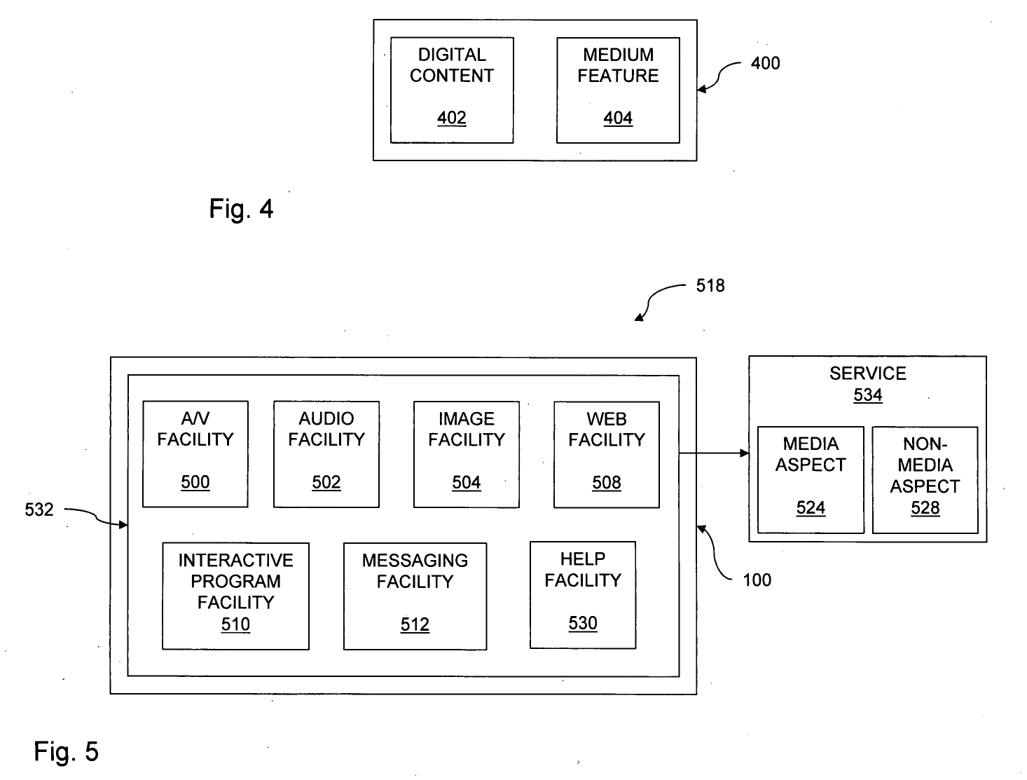

Referring now to FIG. 5, a child-oriented computing system 518 may comprise the computing facility 100, which itself may comprise a service software component 532 directed at children. The service software component 532 may comprise one or more media facilities. These facilities, which are described in detail hereinafter, may allow a user such as a child to access the digital content 402 of the physical medium 400, perhaps without having an adult present to configure, monitor, or enable the content 402 or the medium 400. These facilities may also provide increased reliability as compared with analogous facilities directed at adults. This increased reliability may be provided to compensate for common problems that a child, in particular, may have in configuring, accessing, or otherwise utilizing the content 402 or the medium 400. Other aspects and benefits of the service software component 532 will be appreciated from the following discussion.

In some embodiments, the digital content 402 may be provided as a built-in component or standard feature of the computing facility 100. In other embodiments, the digital content 402 may be provided by the physical medium 400. In still other embodiments, the digital content 402 may be provided as a software download 600. This software download 600 may comprise any of the digital content 402 described herein or appreciated from the present description.

The service software component 532 may provide a service 534. The service 534 may comprise a media aspect 524 and/or a non-media aspect 528. The media aspect 524 may be provided by one or more of the media facilities. The non-media aspect 528 may be provided by a portion of the service software component 532 that is not the media facilities. The service 534 and its aspects are described in detail hereinafter.

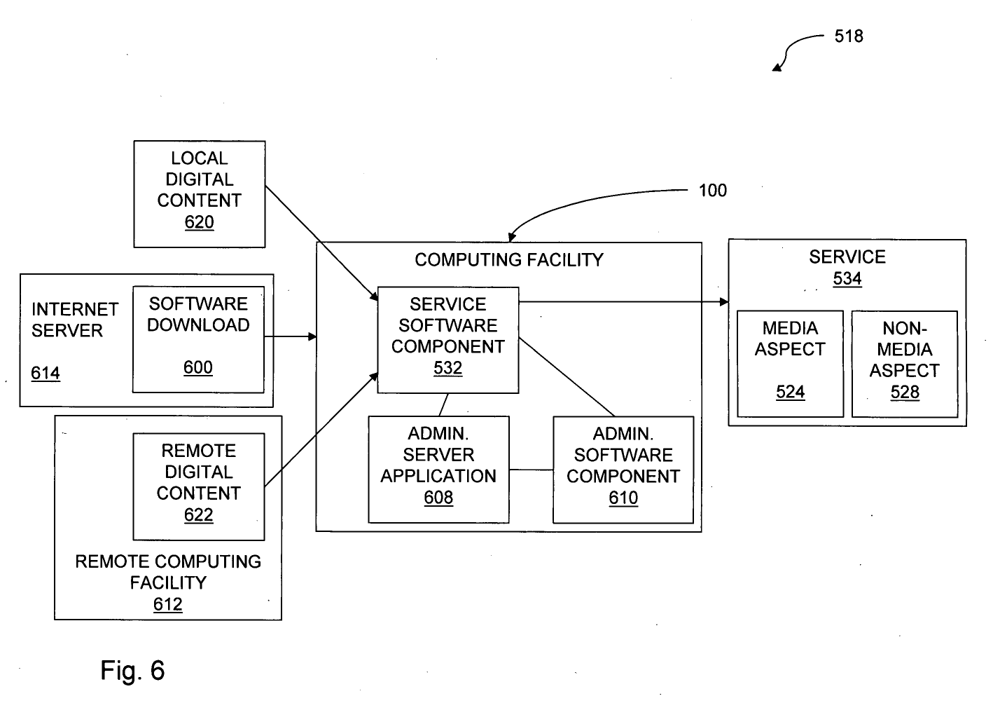

In some embodiments, the service software component 532 may be implemented as software, hardware, or a combination of both software and hardware. This will be appreciated more fully from the following discussion and from the detailed descriptions provided hereinafter with references to FIGS. 6, 7, 8, 9, 10, 11, 12, 13, and 14.

The media facilities of the service software component 532 may comprise an audiovisual facility 500, an audio facility 502, an image facility 504, a Web facility 508, an interactive program facility 510, a messaging facility 512, and a help facility 530. Any or all of the media facilities may be associated with digital content and may provide a rendition of the digital content to the user, such as via the display 102, the speaker 132, and so forth. The audiovisual facility 500 may be associated with audiovisual content, such as and without limitation a television program, a movie, a home video, a real-time video stream, and the like. The audio facility 502 may be associated with audio content, such as and without limitation a song, an audio clip, a real-time audio stream, and the like. The image facility 504 may be associated with still-image content, such as and without limitation a picture, a screenshot, a drawing, and the like. The Web facility 508 may be associated with a Web content, such as and without limitation a static Web page, a dynamic Web page, client-side Web application such as a Java applet or Javascript program, and the like. The interactive program facility 512 may be associated with interactive content, such as and without limitation a computer game, an educational software program, a word processor, spreadsheet program, task list program, calendar program, and so forth. The messaging facility 512 may be associated with an instant message, a textual conversation, a video chat (which may be a special instance of the audiovisual content), an audio chat (which may be a special instance of the real-time audio stream), and so forth. The help facility 530 may be associated with a help feature, such as and without limitation an entertaining help message, a visually demonstrative help message, a one-time help message, a periodic help-message, a start-up help message, an animated cartoon character that provides a help message, and so forth.

Generally, an audiovisual program may be an instance of the digital content 402 and the audiovisual facility 500 may receive, transmit, and/or provide it. The media aspect 524 of the service 534 may comprise this receiving, transmitting, and/or providing. The audiovisual facility 500 may provide a user with the ability to watch a live audiovisual program, perhaps in association with or in accordance with an audiovisual program guide, which in embodiments may be downloaded from the Internet. The audiovisual facility 500 may provide one or more capabilities that may be associated with a digital video recorder, such as a TiVo. These capabilities may comprise an ability to record an audiovisual program according to a schedule or on demand; an ability to pause and resume a live audiovisual program; an ability to play a recorded audiovisual program; an ability to play an on-demand audiovisual program; an ability to fast-forward, rewind, and pause a recorded or on-demand audiovisual program that is being played; an ability to record one audiovisual program while watching another audiovisual program, which may be recorded, live, or on-demand; and so forth. The media aspect 524 may comprise the abilities and capabilities described in this paragraph.

The audiovisual facility 500 may provide a user with an ability to watch an audiovisual program (i.e. an instance of digital content 402) that is stored on and/or provided by an optical disc, memory stick, or other instance of the physical medium 400. For example, the audiovisual facility 500 may provide the ability to play a DVD. The audiovisual facility 500 may additionally provide the user with an ability to receive an instance of digital content 402 that may be associated with the audiovisual program. In embodiments, this instance of digital content 402 may be a digital movie poster and may be downloaded, perhaps automatically, from the Internet. The audiovisual facility 500 may additionally provide the user with an ability to submit a rating directed at an audiovisual program, such as according to a 5-star rating, a point rating on a 10-scale, a thumbs-up/thumbs-down rating, an academic-style A-through-F rating, or any other rating methodology. In some embodiments, the rating may further comprise a textual entry provided by the user. This textual entry may comprise a tag. The audiovisual facility 500 may provide the user with an ability to view a rating provided by a second user. In this way, the user may appreciate the audiovisual program in advance of experiencing it or in the context of the experience of the second user. The media aspect 524 may comprise the abilities described in this paragraph.

In embodiments, the audiovisual facility 500 may provide to the user an ability to receive the audiovisual program either for real-time streaming playback or for storage as an audiovisual file in the local storage facility 118, wherein the file may comprise the audiovisual program. The media aspect 524 may comprise this ability. Receiving the audiovisual program may comprise downloading from a data network connection such as may be associated with the Internet; accepting from a Firewire connection, a USB connection, or other such instance of the physical medium 400; or ripping from a CD, DVD, or other such instance of the physical medium 400. Thus, a plurality of audiovisual programs may be stored as a plurality of audiovisual files in the local storage facility 118.

The audiovisual facility 500 may provide a management capability associated with the plurality of audiovisual programs. This capability may comprise a providing a catalog to the user, wherein the catalog comprises a list of some or all of the plurality of audiovisual files. In the preferred embodiment the catalog may be presented as a hierarchical structure, organized by title, director, actor, subject, release date, MPAA rating, popularity, user rating, or any other information associated with the audiovisual files. The user may be allowed to arrange the catalog, partition the catalog into two catalogs, aggregate two catalogs into one catalog, receive the catalog from a physical medium 400, transmit or record the catalog to a physical medium 400, and so forth. The media aspect 524 may comprise the management capability described in this paragraph.

The audiovisual facility 500 may provide a rendering of a selection of the plurality of audiovisual files according the catalog, such as according to which of the audiovisual files appear in the catalog, the order in which the audiovisual files appear in the catalog, and so forth. The media aspect 524 may comprise this rendering.

Generally, an audio program may be an instance of the digital content 402 and the audio facility 502 may receive, transmit, and/or provide it. The media aspect 524 of the service 534 may comprise this receiving, transmitting, and/or providing. The audio facility 502 may provide a user with the ability to hear a live audio program, perhaps in association with or in accordance with an audio program guide, which in embodiments may be downloaded from the Internet. The audio facility 502 may provide one or more capabilities that may be associated with an audio recorder. These capabilities may comprise an ability to record an audio program according to a schedule or on demand; an ability to pause and resume a live audio program; an ability to play a recorded audio program; an ability to play an on-demand audio program; an ability to fast-forward, rewind, and pause a recorded or on-demand audio program that is being played; an ability to record one audio program while listening to another audio program, which may be recorded, life, or on-demand; and so forth. The media aspect 524 may comprise the abilities and capabilities described in this paragraph.

The audio facility 502 may, for the user, render audible an audio program (i.e. an instance of digital content 402) that is stored on and/or provided by an optical disc, memory stick, or other instance of the physical medium 400. For example, the audio facility 502 may provide the ability to play a CD. The audio facility 502 may additionally provide the user with an ability to receive an instance of the digital content 402 that may be associated with the audio program. In embodiments, this instance of digital content 402 may be a digital CD insert and may be downloaded, perhaps automatically, from the Internet. The audio facility 502 may additionally provide the user with an ability to submit a rating directed at an audio program, such as according to a 5-star rating, a point rating on a 10-scale, a thumbs-up/thumbs-down rating, an academic-style A-through-F rating, or any other rating methodology. In some embodiments, the rating may further comprise a textual entry provided by the user. This textual entry may comprise a tag. The audio facility 502 may provide the user with an ability to view a rating provided by a second user. In this way, the user may appreciate the audio program in advance of experiencing it or in the context of the experience of the second user. The media aspect 524 may comprise the abilities described in this paragraph.

In embodiments, the audio facility 502 may provide to the user an ability to receive the audio program either for real-time streaming playing or for storage as an audio file in the local storage facility 118, wherein the file may comprise the audio program. The media aspect 524 may comprise this ability. Receiving the audio program may comprise downloading from a data network connection such as may be associated with the Internet; accepting from a Firewire connection, a USB connection, or other such instance of the physical medium 400; or ripping from a CD, DVD, or other such instance of the physical medium 400. Thus, a plurality of audio programs may be stored as a plurality of audio files in the local storage facility 118.

The audio facility 502 may provide a management capability associated with the plurality of audio programs. This capability may comprise a providing a playlist to the user, wherein the playlist comprises a list of some or all of the plurality of audio files. In the preferred embodiment the list may be presented as a hierarchical structure, organized by title, artist, album, release date, popularity, user rating, or any other information associated with the audio files. The user may be allowed to arrange the playlist, partition the playlist into two playlists, aggregate two playlists into one playlist, receive the playlist from physical medium 400, transmit or record the playlist to the physical medium 400, and so forth. The media aspect 524 may comprise the management capability described in this paragraph.

The audio facility 502 may provide a rendering of a selection of the plurality of audio files according the playlist, such as according to which of the audio files appears in the playlist, the order in which the audio files appear in the playlist, and so forth. The media aspect 524 may comprise this rendering.

Generally, a digital image may be an instance of the digital content 402 and the image facility 504 may receive, transmit, and/or provide it. The media aspect 524 of the service 534 may comprise this receiving, transmitting, and/or providing. The image facility 504 may provide a user with the ability to view the digital image. The image facility 504 may provide one or more capabilities that may be associated with a photo editor. These capabilities may comprise an ability to manipulate the digital image, such as to crop the image, to reduce red eye of a subject into the image, to rotate the image, to scale the image, and so forth. In embodiments, image may be recorded to the local storage facility 118, from which it may later be rendered. The media aspect 524 may comprise the abilities and capabilities described in this paragraph.

The image facility 504 may provide render visible a digital image (i.e. an instance of digital content 402) that is stored on and/or provided by an optical disc, memory stick, or other instance of the physical medium 400. The image facility 504 may additionally provide the user with an ability to receive an instance of the digital content 402 that may be associated with the digital image. The image facility 504 may additionally provide the user with an ability to submit a rating directed at a digital image, such as according to a 5-star rating, a point rating on a 10-scale, a thumbs-up/thumbs-down rating, an academic-style A-through-F rating, or any other rating methodology. In some embodiments, the rating may further comprise a textual entry provided by the user. This textual entry may comprise a tag. The image facility 504 may provide the user with an ability to view a rating provided by a second user. In this way, the user may appreciate the digital image in advance of experiencing it or in the context of the experience of the second user. The media aspect 524 may comprise the abilities described in this paragraph.

In embodiments, the image facility 504 may provide to the user an ability to receive the digital image either for instant viewing or for storage as an image file in the local storage facility 118, wherein the file may comprise the digital image. The media aspect 524 may comprise this ability. Receiving the digital image may comprise downloading from a data network connection such as may be associated with the Internet; accepting from a Firewire connection, a USB connection, or other such instance of the physical medium 400; or copying from a CD, DVD, or other such instance of the physical medium 400. In some embodiments, the physical medium 400 may be associated with and/or operatively coupled to a digital camera, a Web camera, or any other digital imaging facility. In any case, a plurality of digital images may be stored as a plurality of image files in the local storage facility 118.

The image facility 504 may provide a management capability associated with the plurality of digital images. This capability may comprise providing a photo album to the user, wherein the photo album comprises a list of some or all of the plurality of image files. In the preferred embodiment the list may be presented as thumbnail images in a hierarchical structure, organized by date, subject, color, resolution, user-specified preference, or any other information associated with the image files. The thumbnail images may have a one-to-one correspondence with the plurality of image files. The hierarchical structure may be displayed as images within pages of a photo album, wherein the photo album may contain multiple sections of pages. Alternatively or additionally, the hierarchical structure may be displayed as a tree-like data structure, with a root node, interior nodes, and leaf nodes. Alternatively or additionally, each image in the hierarchy may be displayed either according to a slideshow format (with each image being shown one-by-one, with an automatic progression from one image to the next) or according to a flat representation in which thumbnails of the images are simultaneously displayed. In the case of the flat representation, a user may select one of the thumbnails to view a higher resolution version of the image. The user may be allowed to arrange the images on a page of the photo album, partition a section of the photo album into two sections, aggregate two sections of the photo album into one section of the photo album, receive part or all of the photo album from physical medium 400, transmit or record part or all of the playlist to the physical medium 400, and so forth. The media aspect 524 may comprise the management capability described in this paragraph.

In some embodiments, a plurality of photo albums may be provided. In this case, a representative image taken from each of the albums may be displayed. Alternatively, a plurality of dynamic slideshows, each of which is associated with one of the photo albums, may be displayed. In any case, the user may select which album he wishes to view by choosing the representative image or associated slideshow of the album.

The image facility 504 may provide an easy way for the user to navigate a Web site. All but the simplest of Web sites are hierarchical, with a home page at the root level; with the pages accessible via hyperlink from the home page at a second level that is immediately below the root level; with the pages linked from those pages at a third level that is immediately below the second level, and so forth. Such a hierarchy may be too difficult for a user to navigate, particularly when the user is a young child. To remedy this, the image facility 504 may present a Web site in a flat representation in which each of the pages of the Web site are represented by a thumbnail image, many or all of which may be simultaneously displayed. The user can select a Web page for viewing by choosing the thumbnail image that represents the page. In some embodiments, only a subset of the Web pages of a Web site may be approved for viewing by the user. In this case, thumbnail images for only those approved pages will be provided by the image facility 504.

The image facility 504 may provide a rendering of a selection of the plurality of image files according to their arrangement in the photo album, such as according to which of the image files appear in the photo album, the order in which the image files appear in the photo album, and so forth. This rendering may be presented as a slide show, with one image file being automatically displayed for some amount of time and then a second image file being automatically displayed for some amount of time. The media aspect 524 may comprise this rendering.

Generally, a Web page or component thereof may be an instance of the digital content 402 and the Web facility 508 may receive, transmit, and/or provide it. The media aspect 524 of the service 534 may comprise this receiving, transmitting, and/or providing. The Web facility 508 may provide a user with the ability to view the Web page. The Web facility 508 may provide one or more capabilities that may be associated with a Web browser. These capabilities may comprise an ability to enter information into a field of the Web page; to select an item in the Web page; to interact with a dynamic portion of the Web page; and so forth. In embodiments, perhaps utilizing an automatic technique such as caching or a manual technique such as saving the Web page to disk, the Web page may be recorded to the local storage facility 118, from which it may later be rendered. The media aspect 524 may comprise the abilities and capabilities described in this paragraph.

The Web facility 508 renders visible a Web page (i.e. an instance of digital content 402) that is stored on and/or provided by an optical disc, memory stick, or other instance of the physical medium 400. The Web facility 508 may additionally provide the user with an ability to receive an instance of the digital content 402 that may be associated with the Web page. In embodiments, this instance of the digital content 402 may comprise an advertisement. The Web facility 508 may additionally provide the user with an ability to submit a rating directed at a Web page, such as according to a 5-star rating, a point rating on a 10-scale, a thumbs-up/thumbs-down rating, an academic-style A-through-F rating, or any other rating methodology. In some embodiments, the rating may further comprise a textual entry provided by the user. This textual entry may comprise a tag. The Web facility 508 may provide the user with an ability to view a rating provided by a second user. In this way, the user may appreciate the Web page in advance of experiencing it or in the context of the experience of the second user. The media aspect 524 may comprise the abilities described in this paragraph.

In embodiments, the Web facility 508 may provide to the user an ability to receive the Web page either for instant viewing or for storage as a file-based representation in the local storage facility 118, wherein the file-based representation may comprise the Web page. The media aspect 524 may comprise this ability. Receiving the Web page may comprise downloading from a data network connection such as may be associated with the Internet; or copying from a CD, DVD, or other such instance of the physical medium 400. A plurality of Web pages be stored as a plurality of file-based representations in the local storage facility 118.

The Web facility 508 may provide a management capability associated with the plurality of Web pages. This capability may comprise providing bookmarks to the user, wherein the bookmarks comprise a list of some or all of the plurality of Web pages. In the preferred embodiment the bookmarks may be presented in a hierarchical structure, organized by date, subject, keyword, tag, user-specified preference, or any other information associated with the Web pages. The hierarchical structure may be displayed as a tree-like data structure, with a root node, interior nodes, and leaf nodes. The user may be allowed to arrange the bookmarks, partition the bookmarks into two sets of bookmarks, aggregate two sets of bookmarks into one set of bookmarks, receive some or all of the bookmarks from physical medium 400, transmit or record some or all of the bookmarks to the physical medium 400, and so forth. The media aspect 524 may comprise the management capability described in this paragraph.

The Web facility 508 may providing a rendering of a selection of the plurality of Web pages according the arrangement of the bookmarks, such as according to which of the bookmarks are present, the order in which the bookmarks appear, and so forth. This display of a selection of the plurality of Web pages may be presented in multiple browser tabs, with a one-to-one correspondence between the bookmarks and the tabs. The media aspect 524 may comprise this rendering.

Generally, an interactive computer program may be an instance of the digital content 402 and the interactive program facility 501 may receive, transmit, and/or provide it. The media aspect 524 of the service 534 may comprise this receiving, transmitting, and/or providing. The interactive program facility 510 may provide a user with the ability to utilize the interactive computer program, such as and without limitation to interact with a user interface provided by the interactive computer program. The interactive program facility 510 may provide one or more capabilities that may be associated with a computer game, an educational computer program, and the like. In embodiments, the interactive computer program may be recorded to the local storage facility 118, from which it may later be launched. The media aspect 524 may comprise the abilities and capabilities described in this paragraph.

The interactive program facility 510 may provide a user with an ability to utilize the interactive computer program (i.e. an instance of digital content 402) that is stored on and/or provided by an optical disc, memory stick, or other instance of the physical medium 400. The interactive program facility 510 may additionally provide the user with an ability to receive an instance of the digital content 402 that may be associated with the Web page. In embodiments, this instance of the digital content 402 may comprise an advertisement. The interactive program facility 510 may additionally provide the user with an ability to submit a rating directed at an interactive computer program, such as according to a 5-star rating, a point rating on a 10-scale, a thumbs-up/thumbs-down rating, an academic-style A-through-F rating, or any other rating methodology. In some embodiments, the rating may further comprise a textual entry provided by the user. This textual entry may comprise a tag. The interactive program facility 510 may provide the user with an ability to view a rating provided by a second user. In this way, the user may appreciate the interactive computer program in advance of experiencing it or in the context of the experience of the second user. The media aspect 524 may comprise the abilities described in this paragraph.

In embodiments, the interactive program facility 510 may provide to the user an ability to download an interactive computer program from a data network connection such as may be associated with the Internet; or to copy the interactive computer program from a CD, DVD, or other such instance of the physical medium 400. The media aspect 524 may comprise this ability. A plurality of interactive computer programs may be stored as a plurality of file-based representations in the local storage facility 118.

The interactive program facility 510 may provide a management capability associated with the plurality of interactive computer programs. This capability may comprise a providing a catalog to the user, wherein the catalog comprises a list of some or all of the plurality of interactive computer programs. In the preferred embodiment the catalog may be presented as a hierarchical structure, organized by title, publisher, subject, release date, ESRB rating, popularity, user rating, or any other information associated with the plurality of interactive computer programs. The user may be allowed to arrange the catalog, partition the catalog into two catalogs, aggregate two catalogs into one catalog, receive the catalog from a physical medium 400, transmit or record the catalog to a physical medium 400, and so forth. This management capability may further allow for the installation, execution, and/or removal of an interactive computer program. The media aspect 524 may comprise the management capability described in this paragraph.

Generally, an e-mail message, an instant message, audio-chat message, video-chat message, instant message session, audio-chat session, or video-chat session (collectively referred to as “a message”) may be an instance of the digital content 402 and the messaging facility 512 may receive, transmit, and/or provide it. The media aspect 524 of the service 534 may comprise this receiving, transmitting, and/or providing. The messaging facility 512 may provide a user with the ability to utilize a message, such as and without limitation to create the message, to transmit the message, to receive the message, to see the message, to hear the message, and/or to otherwise render the message. The messaging facility 512 may provide one or more capabilities that may be associated with a message, such as to accept the message (manually or automatically), reject the message (manually of automatically), filter message, respond to the message (manually or automatically), participate in the message, and so forth. Thus, the messaging facility 512 may enable one user to communicate with another user, in a real-time or asynchronous fashion. In embodiments, the message may be recorded to the local storage facility 118, from which it may later be utilized. The media aspect 524 may comprise the abilities and capabilities described in this paragraph.

When the messaging facility 512 filters the message, one aspect of the filtering may relate to looking forward a word or phrase that is classified as inappropriate. Such classification may be automatically provided by or built into the messaging facility 512 and/or may be specified by a user or an administrative user. When an inappropriate word or phrase is detected in a message, the messaging facility 512 may take an action. The action could be a default action or an action specified by the user or the administrative user. In any case, the action may be to reject the message; to warn or notify the administrative user about the message; and/or to warn or notify the user about the message. The warning or notification may take the form of a text message, an audio message or tone, a dynamic thermometer icon that displays a hotter temperature when the inappropriate word or phrase is detected; a dialog box; a visual indication; and so forth.

The messaging facility 512 may provide a user with an ability to utilize the message (i.e. an instance of digital content 402) that is stored on and/or provided by an optical disc, memory stick, or other instance of the physical medium 400. The interactive program facility 510 may additionally provide the user with an ability to receive an instance of the digital content 402 that may be associated with the message. In embodiments, this instance of the digital content 402 may comprise a graphical emoticon. The messaging facility 512 may additionally provide the user with an ability to submit a rating directed at a message, such as according to a 5-star rating, a point rating on a 10-scale, a thumbs-up/thumbs-down rating, an academic-style A-through-F rating, a spam/not-spam rating, or any other rating methodology. In some embodiments, the rating may further comprise a textual entry provided by the user. This textual entry may comprise a tag. The messaging facility 512 may provide the user with an ability to view a rating provided by or associated with a second user. In this way, the user may appreciate the message and/or the second user in advance of experiencing the message. The media aspect 524 may comprise the abilities described in this paragraph.

In embodiments, the messaging facility 512 may provide to the user an ability to download a message from a data network connection such as may be associated with the Internet; or to copy the message from a CD, DVD, or other such instance of the physical medium 400. The media aspect 524 may comprise this ability. A plurality of messages may be stored as a plurality of file-based representations in the local storage facility 118.

The messaging facility 512 may provide a management capability associated with the plurality of messages. This capability may comprise a providing a catalog to the user, wherein the catalog comprises a list of some or all of the plurality of messages. In the preferred embodiment the catalog may be presented as a hierarchical structure, organized by identity of the second user, popularity, rating, keyword, tag, or any other information associated with the messages. The user may be allowed to arrange the catalog, partition the catalog into two catalogs, aggregate two catalogs into one catalog, receive the catalog from a physical medium 400, transmit or record the catalog to a physical medium 400, and so forth. The media aspect 524 may comprise the management capability described in this paragraph.

The messaging facility 512 may provide an ability to display, to archive, and/or to retrieve of one or more of the messages. The media aspect 524 may comprise this ability.

Generally, a help feature (and the like) may be an instance of the digital content 402 and the help facility 530 may transmit and/or provide it. The media aspect 524 of the service 534 may comprise this transmitting and/or providing. The help facility 530 may provide a user with the ability to utilize a help feature, such as and without limitation to receive the help feature, to see the help feature, to hear the help feature, and/or to otherwise render the help feature. The help facility 530 may provide one or more capabilities that may be associated with a help feature, such as providing the feature once, periodically, autonomously, in response to a user input, and so forth. Thus, the help facility 530 may enable one user to receive a help feature at an appropriate and/or convenient time. In embodiments, the help feature may be recorded to the local storage facility 118, from which it may later be utilized. The media aspect 524 may comprise the abilities and capabilities described in this paragraph.

The help facility 530 may render usable a help feature (i.e. an instance of digital content 402) that is stored on and/or provided by an optical disc, memory stick, or other instance of the physical medium 400. The help facility 530 may additionally provide the user with an ability to receive an instance of the digital content 402 that may be associated with the message. In embodiments, this instance of the digital content 402 may comprise a hyperlink to a live help session. The help facility 530 may additionally provide the user with an ability to submit a rating directed at a help feature, such as according to a 5-star rating, a point rating on a 10-scale, a thumbs-up/thumbs-down rating, an academic-style A-through-F rating, or any other rating methodology. In some embodiments, the rating may further comprise a textual entry provided by the user. This textual entry may comprise a tag. The help facility 530 may provide the user with an ability to view a rating provided by or associated with a second user. In this way, the user may appreciate the help feature in advance of experiencing the help feature. The media aspect 524 may comprise the abilities described in this paragraph.

In embodiments, the help facility 530 may provide to the user an ability to download a help feature from a data network connection such as may be associated with the Internet; or to copy the help feature from a CD, DVD, or other such instance of the physical medium 400. The media aspect 524 may comprise this ability. A plurality of help features may be stored as a plurality of file-based representations in the local storage facility 118.

The help facility 530 may provide a management capability associated with the plurality of help features. This capability may comprise a providing a catalog to the user, wherein the catalog comprises a list of some or all of the plurality of help features. In the preferred embodiment the catalog may be presented as a hierarchical structure, organized by subject, rating, keyword, tag, or any other information associated with the help features. The user may be allowed to arrange the catalog, partition the catalog into two catalogs, aggregate two catalogs into one catalog, receive the catalog from a physical medium 400, transmit or record the catalog to a physical medium 400, and so forth. The media aspect 524 may comprise the management capability described in this paragraph.

The help facility 530 may provide an ability to display, to archive, and/or to retrieve one or more of the help features. The media aspect 524 may comprise this ability.

The service software component 532 may further comprise an aspect directed at compensating for a user-introduced, unintentional medium feature 404. The media aspect 524 may comprise this aspect. In one example, the medium feature 404 is a scratch, which may render the physical medium 400 partly or completely ruined. Prior to the introduction of this medium feature 404, this aspect of the service software component 532 may store the digital content 402 to the local storage facility 118. Thenceforth, the presence or proper functioning of the physical medium 400 may be unnecessary, since the digital content 402 is available from the local storage facility 118. This aspect may cut across all of the elements of the service software component 532, applying more or less equally both to all of them and to all of the possible forms of digital content 402 that may be associated with them. It should be appreciated that this aspect may provide a user such as a child with increased and reliable access to the digital content 402 within with the physical medium 400.

Referring now to FIG. 6, a child-oriented computing system 518 may be provided. On the one hand, the computing system 518 may be directed at providing a child with reliable access to digital content 402, even when an adult is not present. On the other hand, the computing system 518 may be directed at limiting the child's access to digital content 402, such as according to an access control rule specified or otherwise imposed by the adult. This system 518 may comprise an instance of local digital content 620; an instance of remote digital content 622, provided by a remote computing facility 612; a software download 600, provided by an Internet server 614; a service 534; and the computing facility 100, which may comprise a service software component 532; an administrative server application 608; and an administrative software component 610.

The service software component 532 of the computing facility 100 may provide the service 534, which may be provided by the service software component 532 and, thus, may be any of the features, functions, or aspects of the service software component 532. In some embodiments, the service software component 532 may be provided as a built-in component or standard feature of the computing facility 100. In other embodiments, the software download 600 may, in whole or in part, provide the service software component 532 to the computing facility 100. This software download 600 may comprise an installer, an update, an upgrade, a bug fix, a security patch, and the like.

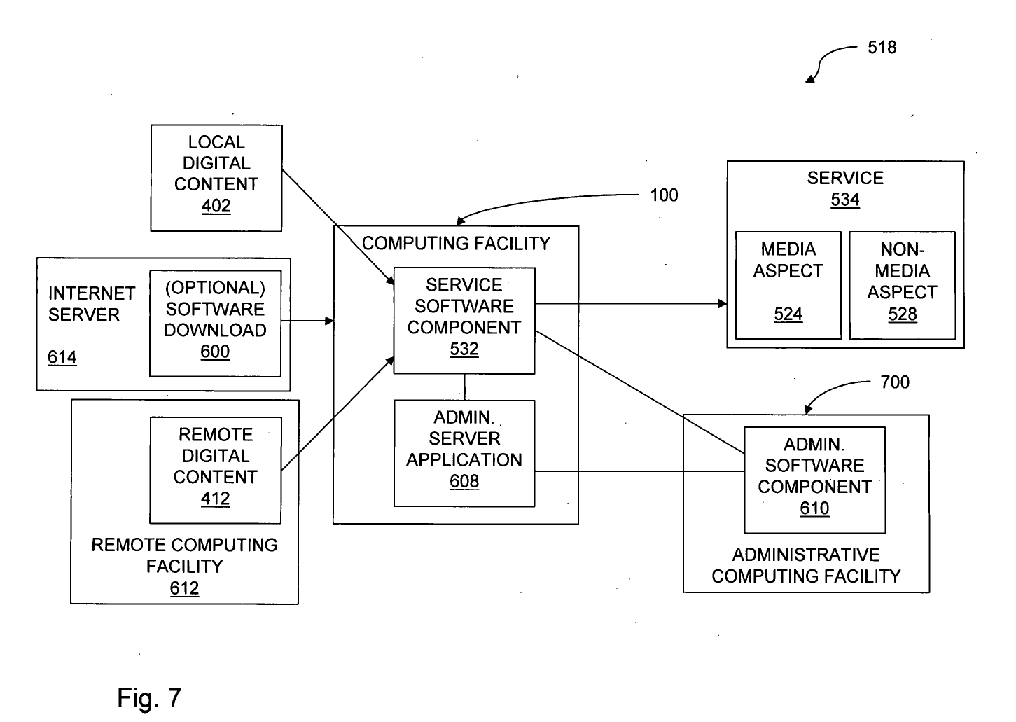

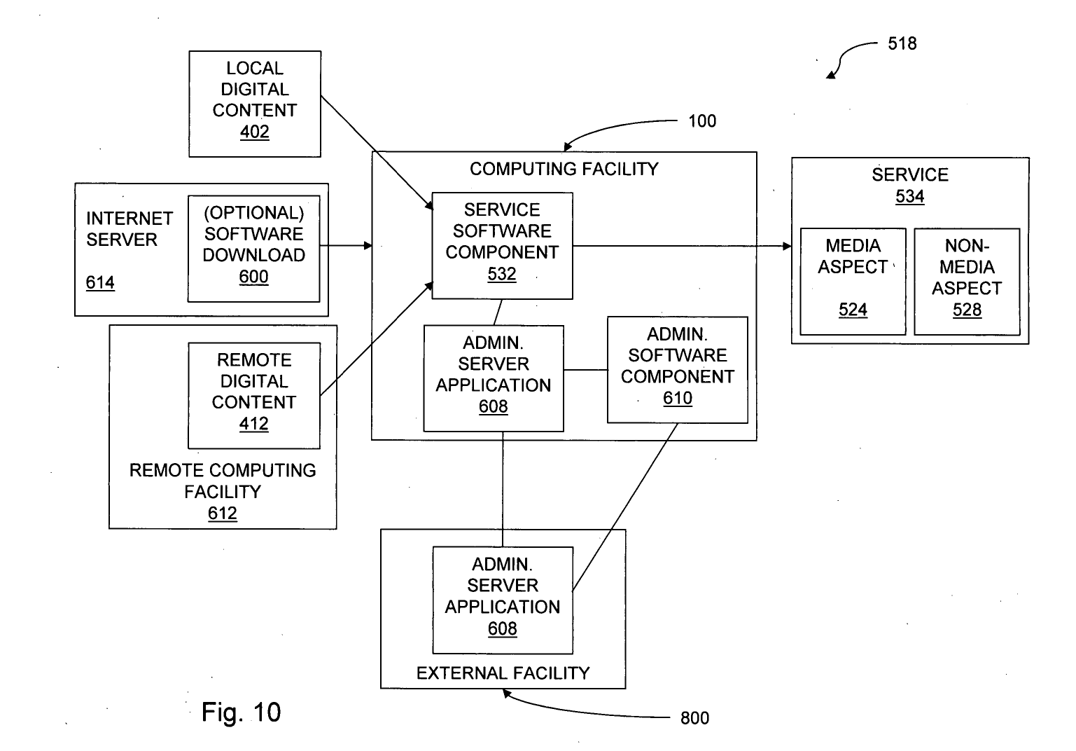

The service software component 532 may comprise a proprietary software application, an open-source application, a Web browser, a multimedia application, an audio application, an image-related application, an instant messaging application, or any other application that provides the service 534. The service software component 532 may be associated with the administrative server application 608 and/or the administrative software component 610. In the depicted embodiment, the computing facility 100 may comprise both the administrative server application 608 and the administrative software component 610. However, in other embodiments described hereinafter with references to FIGS. 7; 8; 9; 10; 11; 12; and 13, it will be shown that the computing facility 100 may not comprise the administrative server application 608 and/or the administrative software component 610. In some embodiments, described hereinafter with references to FIGS. 10; 11; 12; 13; and 14, it will be shown that multiple instances of the administrative server application 608 and/or the administrative software component 610 may be present.

The administrative server application 608 may be a software component that may be associated with the service software component 532 and the administrative software component 610. The nature of these associations is described in detail hereinafter with reference to FIG. 1. In some embodiments, the administrative server application 608 may be provided as a built-in component or standard feature of the computing facility 100. In other embodiments, the software download 600 may, in whole or in part, provide the administrative server application 608 to the computing facility 100. This software download 600 may comprise an installer, an update, an upgrade, a bug fix, a security patch, and the like.

The administrative software component 610 may be associated with the service software component 532 and the administrative server application 608. The nature of these associations is described in detail hereinafter with reference to FIG. 1. In some embodiments, the administrative software component 610 may be provided as a built-in component or standard features of the computing facility 100. In some embodiments, the software download 600 may, in whole or in part, provide the administrative software component 610 to the computing facility 100. This software download 600 may comprise an installer, an update, an upgrade, a bug fix, a security patch, and the like. In the preferred embodiment, the administrative software component 610 may comprise a Web browser.

The service 534, generally speaking, may relate to the service software component 532. Some embodiments of the service 605 are described hereinafter. It will be appreciated, however, that there exists a vast number of possible embodiments of the service 534. Thus, to the broadest extent allowed under the law, all possible embodiments of the service 534 are intended to fall within the scope of the present invention.

The local digital content 620 may comprise the digital content 402 and may be created at the computing facility 100 by a user of the computing facility. To create this digital content 402 the user may utilize an input device such as and without limitation a keyboard, a mouse, a microphone, a digital still camera, a video camera or Webcam, and the like. The local digital content 620 may be provided to the service software component 532 and may be received by any of the service software component 532.

The remote digital content 622 may comprise the digital content 402 and may be provided by a remote computing facility 612. The remote computing facility 612 may be any computing facility, including without limitation a server computer, a personal computer, a portable computer, a Palm Pilot, a cell phone, and so forth. The remote digital content 622 may be provided to the service software component 532 and may be received by and of the service software component 532. In embodiments, this provision may occur via an Internet connection between the computing facility 100 and the remote computing facility 612. The connection between the computing facility 100 and the remote computing facility 612 may comprise an operative coupling between the two.

The software download 600 may be received by the computing facility 100 over an Internet connection from an Internet server 614. The Internet server 614 may comprise a server computer, a tower computer, a rackmount computer, and the like. The Internet connection from the Internet server 614 to the computing facility 100 may comprise an operative coupling between the two.

The administrative server application 608, in association with the administrative software component 610 and the service software component 532, may provide the non-media aspect 528 of the service 534. Generally, the administrative software component 610 may provide an administrative user interface through which an administrative user may specify and/or perform a monitoring and/or controlling of a user's access to the media aspect 524. In the preferred embodiment, the user is a child and the administrative user is a parent of the child; a guardian of the child; an adult responsible for the child (such as and without limitation a teacher, a tutor, a caregiver, and the like); or a delegate designated by the parent, guardian, or adult. In any case, the administrative user may be desirous of and/or responsible for monitoring and/or approving the child's access to the media aspect 524. The non-media aspect 528 of the service 534 may comprise this monitoring and/or approving. Information associated with the monitoring may be stored as an activity log file, which may comprise indicia of the activities of a user vis-a-vis the computing facility 100.

When providing the service 534, the service software component 532 may report to, confer with, and/or check information associated with or provided by the administrative server application 608 and/or the administrative software component 610. Generally speaking, the non-media aspect 528 may control access to a media aspect 524.

In one embodiment, the non-media aspect 524 may be the service software component's 532 checking to see if the media aspect 524 is associated with a whitelist provided by the administrative server application 608. In an alternate embodiment, the non-media aspect 524 may be the service software component's 532 providing to the administrative server application 608 information identifying the media aspect 524 and the administrative server application 608 may check to see if the media aspect 524 identified by the information is associated with the whitelist. In any case, if the media aspect 524 is associated with the whitelist, then the user may be allowed to receive the media aspect 524. Otherwise, the user may not be allowed to receive the media aspect 524.

The whitelist may comprise a list of approved Web sites and/or a list of approved media types (such as and without limitation audio, video, audio-video, interactive content, text, instant message, video chat, audio chat, and so forth). The administrative user may specify the approved Web sites and/or approved media types that appear in the whitelist. In some embodiments, the whitelist may comprise a categorization of the approved Web sites and/or approved media types. In these embodiments, each of the Web sites and/or media types may be associated with one or more categories (such as and without limitation, educational, entertainment, edutainment, free, pay-per-use, English-language, third-party-approved content, and so forth). The administrative user may be able to include or exclude Web sites and/or media types from the whitelist by selecting or deselecting a category that is associated with the Web sites and/or the media types.

In another example, the non-media aspect 528 may comprise an e-mail address and/or an instant messaging address, moniker, handle, or the like. The administrative user may specify the e-mail address and/or the instant message address via the administrative software component 610. Then, the service software component 532 may allow the first user to access a service 534 that comprises a media aspect 524 and the non-media aspect 528. The non-media aspect 528 may comprise an e-mail address and the media aspect 524 may comprise an e-mail message originating from or destined to the e-mail address. The non-media aspect 528 may comprise an instant messaging address and the media aspect 524 may comprise an instant message to the instant messaging address; an instant message from the instant messaging address; an instant messaging session that includes instant messages to and/or from the instant messaging address. The non-media aspect 528 may comprise a video chat address and the media aspect 524 may comprise a video chat session that include a video stream to and/or from the video chat address. Many other examples of pairs of media aspects 524 and non-media aspects 528 will be appreciated.

In another example, the non-media aspect 528 may comprise access to an educational item. The educational item may without limitation comprise an educational game, an educational Web site, an online reference that is associated with education (e.g. a dictionary, encyclopedia, blog, and so forth), a software tool for writing a report, a software tool for creating a presentation, a software tool for performing a calculation, and so forth. The administrative user may specify, such as via the administrative software component 610, one or more educational items as being accessible to the first user. The whitelist may be comprised of the educational items, references thereto, or identifiers thereof, any of which may be checked by the service software component. 532 prior to allowing the first user to receive a service 534 comprising the educational item as the media aspect 524 and access to the educational item as the non-media aspect 528.

In still another example, the non-media aspect 524 may comprise access to a help feature, which may comprise an entertaining and/or visually demonstrative help feature. The help feature may be provided by the help facility 530, described hereinabove with reference to FIG. 5. The user may receive a service 534 comprising the help feature as the media aspect 524 and the timing of the provision of the help feature (e.g. periodically, from time to time, autonomously, on request, on startup, etc.) may comprise the non-media aspect 428.

In another example, the non-media aspect 524 may comprise a parental control, which may comprise a time limitation associated with one or more of the following: using the computing facility 100, watching television, watching a recorded program, playing a game, surfing the Internet, watching a video, watching a DVD, playing a song, communicating with a person via the Internet, using a particular software program, and so forth. Alternatively or additionally, the parental control may be associated with a schedule according to which one or more of the following may be accessed: the computing facility 100, a television program, a recorded program, a computer game, the Internet, a video, a DVD, a song, an instant messaging or video-chat session, a software program, and so forth. The parental control may comprise and/or be associated with a list of approved television channels, a list of approved television shows, a list of Web sites approved for Web surfing (e.g. the whitelist), a list of approved e-mail addresses, a list of approved instant messaging addresses, a list of approved video-chat or video conferencing addresses, a list of approved phone numbers, a content rating level, a list of friends (with whom the first use is authorized to e-mail, text message, video chat, share documents with, and so forth). Alternatively or additionally, the parental control may be associated with adding and/or removing software and/or content from the computing facility 100.

In some embodiments, the non-media aspect 524 may comprise a parental control that is associated with the completion of a task by the user of the computing facility 100. For example and without limitation, the parental control may allow the user to have access to a computer game, but only after a homework assignment is complete. Many other examples will be apparent.

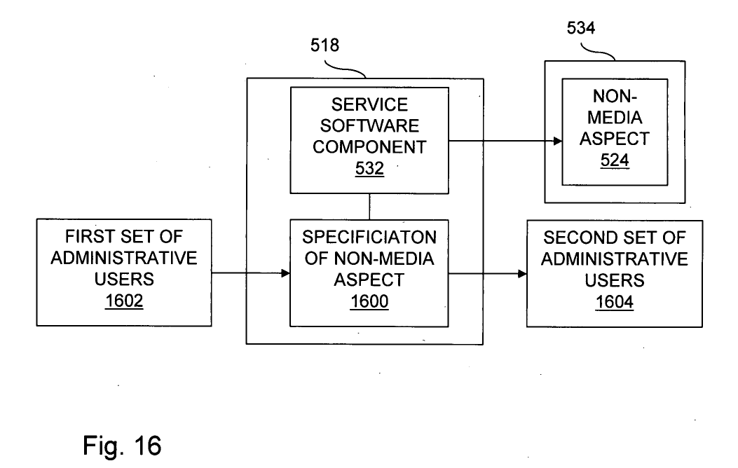

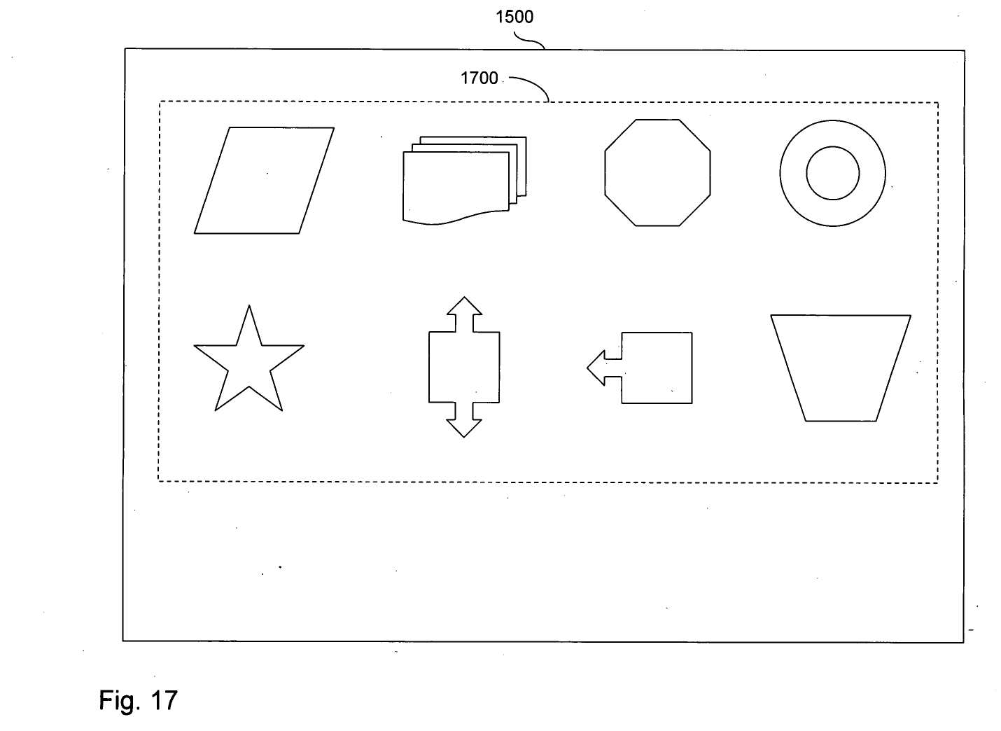

Referring to FIG. 16, a specification 1600 of a non-media aspect 524 may be provided by a first set of administrative users 1602 and received by second set of administrative users 1604. Both sets of administrative users may have a cardinality of one or more. These sets may or may not be disjoint and may or may not be equal. Thus, administrative users may share specifications 1600 with each other, receive specifications 1600 from other administrative users, or provide specifications 1600 to other users. In one embodiment, a self-selected group of administrative users, such as a couple or group of adult family members, may share specifications with each others. In another embodiment, an administrator such as a parent may choose to receive specifications from a first set of administrative users such as a school, religious organization, trusted third party, and the like. Many other such examples will be appreciated. The sharing may occur in real-time, periodically, sporadically, automatically, in response to a manual input, and so forth. In all cases, the child-oriented computing facility 518 may receive the specification 1600 from the first set of administrative users 1602, store the specification 1600, and provide the specification 1600 to the second set of administrative users 1604. The service software component 532 may provide the non-media aspect 524 of the service 534 in accordance with the specification, which may be embodied as digital information, which may be stored or accessed by an element of the child-oriented computing system 518.

Referring now to FIG. 7, the child-oriented computing system 518 may comprise the elements described hereinabove with reference to FIG. 6, with the following modifications: The computing facility 100 may not comprise the administrative software component 610. Instead, an administrative computing facility 700 may comprise the administrative software component 610. The administrative computing facility 700 may comprise any computing facility, such as and without limitation a server computer, a personal computer, a portable computer, a cell phone, a Palm Pilot, a Blackberry, and so forth. In the preferred embodiment, the administrative computing facility 700 comprises a personal computer. The administrative computing facility 700 may be under the control of an adult. The administrative computing facility 700 and its components may be operatively coupled to the elements of the computing facility 100 via an Internet connection.

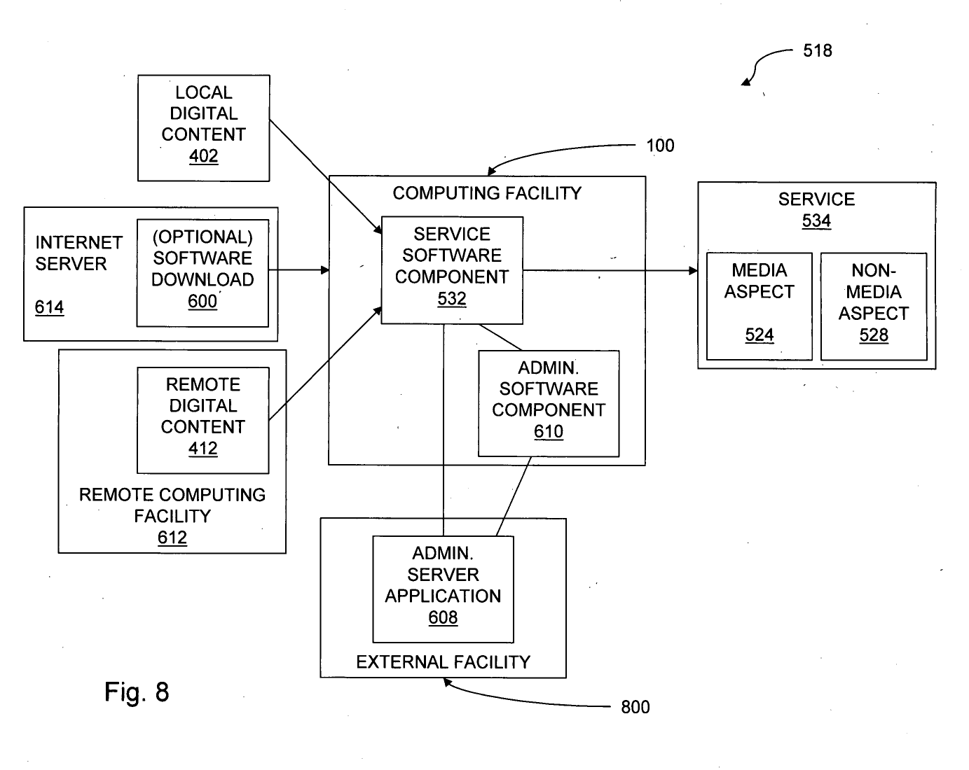

Referring now to FIG. 8, the child-oriented computing system 518 may comprise the elements described hereinabove with reference to FIG. 6, with the following modifications: The computing facility 100 may not comprise the administrative server application 608. Instead, an external facility 800 may comprise the administrative server application 608. The external facility may comprise any computing facility, such as and without limitation a server computer, a personal computer a portable computer, a cell phone, a Palm Pilot, a Blackberry, and so forth. In the preferred embodiment, the external facility 800 comprises a server computer. The administrative server application 608 may be provided as and/or accessed as a service, such as in a service-oriented architecture and/or an application service provider business model. The external facility 800 and its components may be operatively coupled to the elements of the computing facility 100 via an Internet connection.

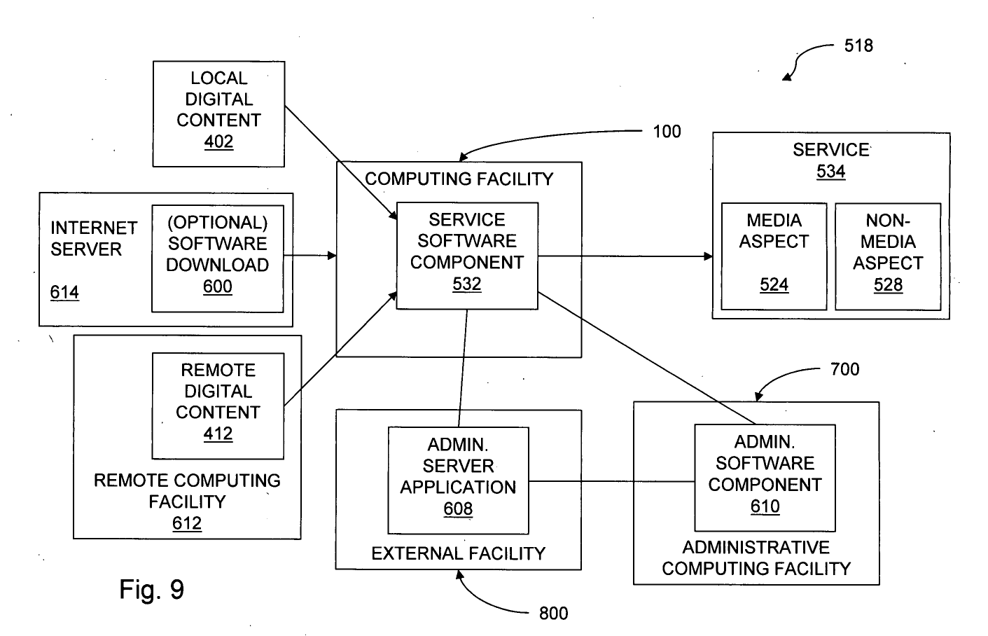

Referring now to FIG. 9, the child-oriented computing system 518 may comprise the elements described hereinabove with reference to FIG. 6, with the following modifications: The computing facility 100 may comprise neither the administrative software component 610 nor the administrative server application 608. Instead, the external facility 800 may comprise the administrative server application 608 (as described hereinabove with reference to FIG. 8) and the administrative computing facility 700 may comprise the administrative software component 610 (as described hereinabove with reference to FIG. 7). The external facility 800, the administrative computing facility 700, the computing facility 100, and their respective components may be operatively coupled via an Internet connection.

Referring now to FIG. 10, the child-oriented computing system 518 may comprise the elements described hereinabove with reference to FIG. 6, with the following modifications: The external facility 800 is provided. The external facility 800 contains an instance of the administrative server application 608, which may be associated with the administrative server application 608 of the computing facility 100. This association, from time to time, may comprise an operative coupling between the administrative server applications 608 over which a signal may be passed from one of the administrative server applications 608 to the other. Also, the administrative software component 610 may be associated with both the administrative server application 608 of the computing facility 100 and the administrative server application 608 of the external facility 800. In this embodiment, some aspects of the administrative server application 608 my be provided by the instance 608 of the computing facility 100, while other aspects may be provided by the instance 608 of the external facility 800. For one example, the categorization of Web sites may be provided by a third-party who may, perhaps for a fee such as a subscription fee, operate the external facility 800. From time to time, the instance 608 of the computing facility 100 may retrieve the categorization so that it may be applied locally according to input received from the administrative software component 610.

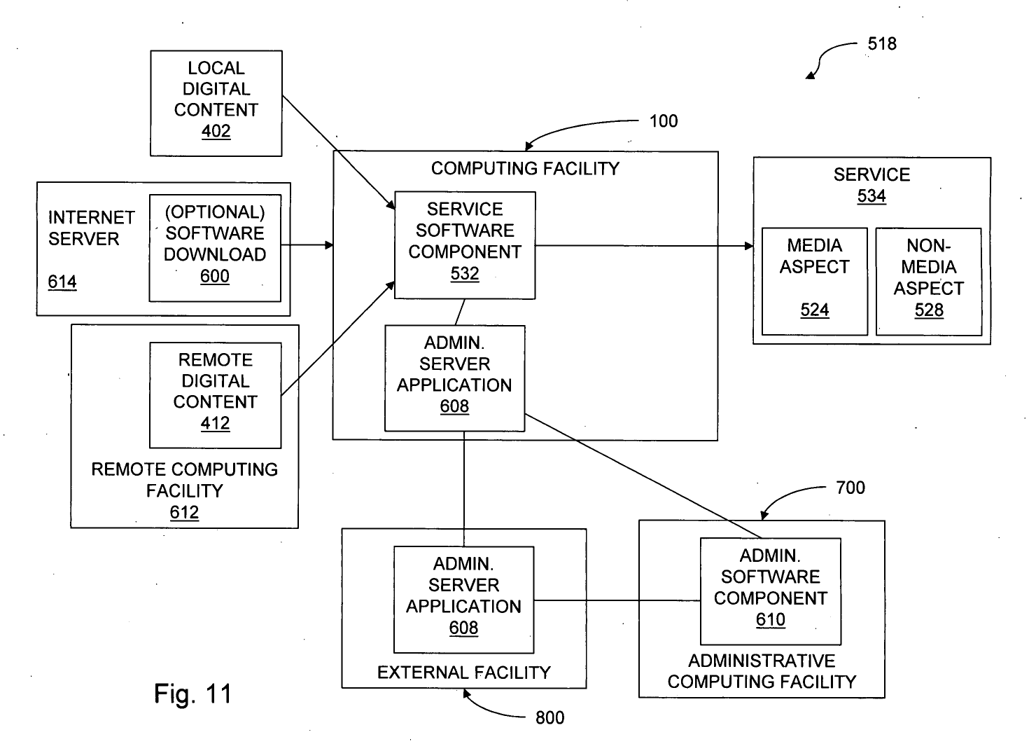

Referring now to FIG. 11, the child-oriented computing system 518 may comprise the elements described hereinabove with reference to FIG. 6, with the following modifications: As was described hereinabove with reference to FIG. 10, the external facility 800 and its instance of the administrative server application 608 is provided. Also, as described hereinabove with reference to FIG. 7, the computing facility many not comprise the administrative software component 610. Instead, the administrative computing facility 700 and its instance of the administrative software component 610 may be provided. The embodiment is analogous to that described hereinabove with reference to FIG. 7, except that, for example, the administrative user may not provide administrative input and/or receive administrative output (such as a report associated with the usage of the computing facility 100 by the first user) at the computing facility 100. Instead, the adult must use the administrative computing facility 700.

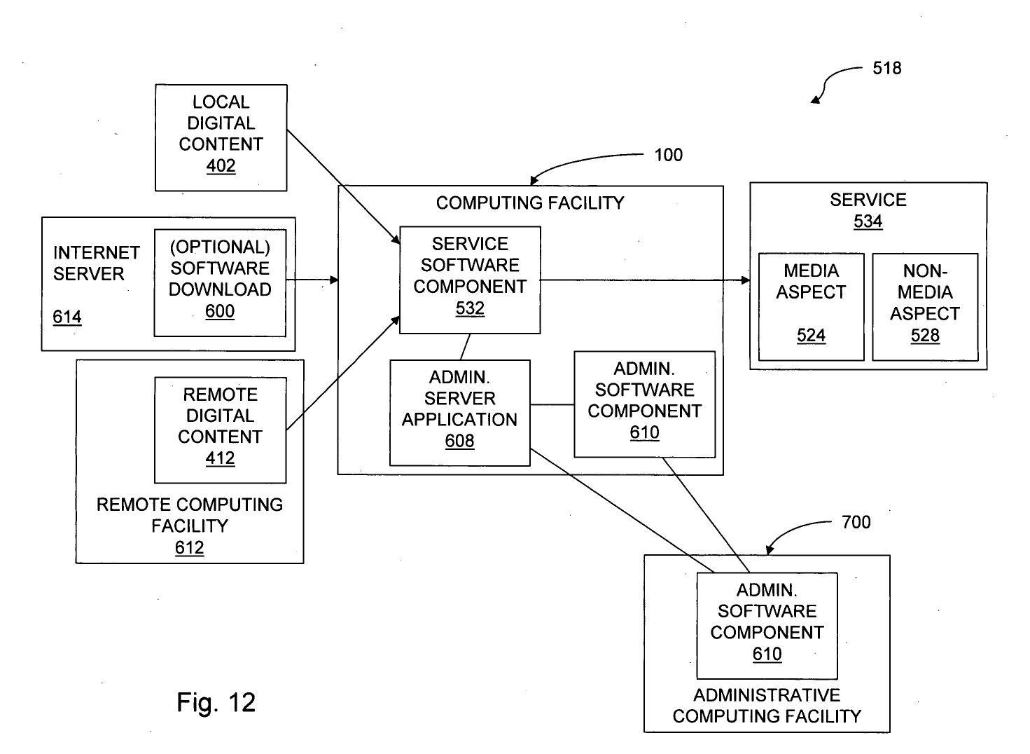

Referring now to FIG. 12, the child-oriented computing system 518 may comprise the elements described hereinabove with reference to FIG. 6, with the following modifications: The administrative computing facility 700 and its instance of the administrative software component 610 (as described hereinabove with reference to FIG. 7) may be provided, which may be associated with the administrative software component 610 of the computing facility 100. This association, from time to time, may comprise an operative coupling between the administrative software components 610 over which a signal may be passed from one of the administrative software components 610 to the other. For example, the administrative user may provide administrative input and/or receive administrative output either at the computing facility 100 or via the administrative computing facility 700.

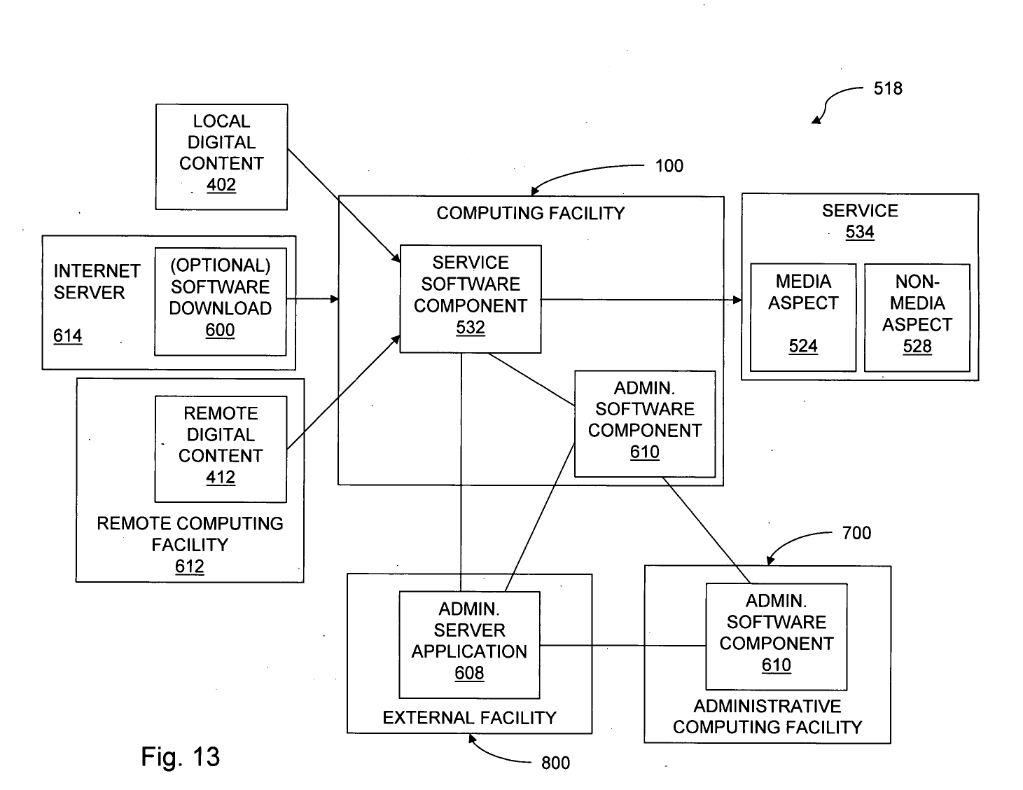

Referring now to FIG. 13, the child-oriented computing system 518 may comprise the elements described hereinabove with reference to FIG. 6, with the following modifications: As was described hereinabove with reference to FIG. 8, the external facility 800 and its instance of the administrative server application 608 is provided, while the computing may not comprise the administrative server application 608. Additionally, as described hereinabove with reference to FIG. 12, the administrative computing facility 700 and its instance of the administrative software component 610 may be provided. This arrangement may provide two major advantages as compared with other embodiments. Like the embodiments described hereinabove with reference to FIG. 12, the administrative user has the freedom to access and/or provide administrative information at the computing facility 100 or via the administrative computing facility 700. Moreover, the entire administrative server application 608 is maintained at the external facility 800, which may allow multiple instances of the computing facility 100 (such as, multiple computing facilities distributed throughout a house) to share the information, services, and features of the administrative server application 608. This may provide a convenient way to have the same non-media aspects 528 provided at each of the computing facilities 100, since they are all provided in association with the same administrative server application 608.

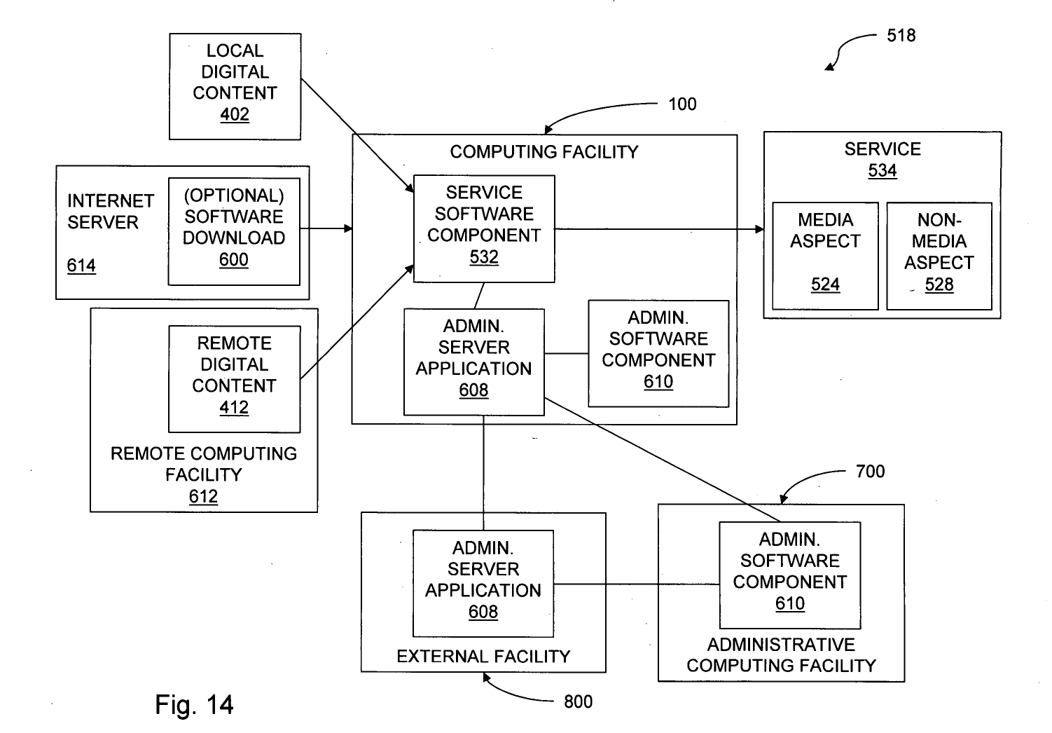

Referring now to FIG. 14, the child-oriented computing system 518 may comprise the elements described hereinabove with reference to FIG. 6, with the following modifications: As was described hereinabove with reference to FIG. 8, the external facility 800 and its instance of the administrative server application 608 is provided. Additionally, as described hereinabove with reference to FIG. 12, the administrative computing facility 700 and its instance of the administrative software component 610 may be provided. This embodiment may provide all of the advantages of the embodiment described hereinabove with reference to FIG. F14, with the added advantage that the computing facility 100 may function properly in the occasional absence of the external facility 800, such as due to a system failure of the external facility 800.

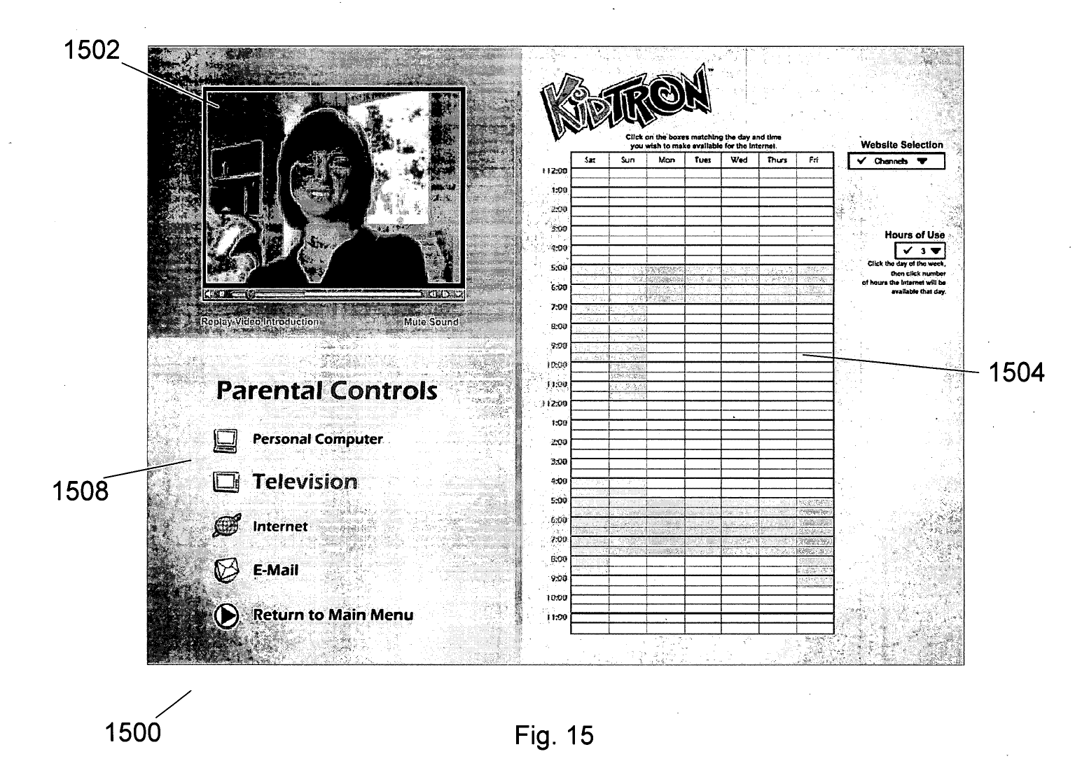

FIG. 15 illustrates an administrative user interface 1500, which may be provided by the administrative software component 610. The administrative user interface 1500 includes features directed at regulating parental controls of over certain activities on the computer facility 100 according to principles of the present invention. In this embodiment, the administrative user may be presented with a control panel including parental controls 1508 directed at the functions, features and services provided to the user by the computing facility 100 (e.g. television, personal computer, Internet, e-mail, instant message, or other functions permitted on the computing facility 100, such as those provided by the service software component 532). For example, the administrative user may choose one of the functional representations (e.g. television). After selecting the representation, the administrative user may be presented with a calendar with times of day 1504, or other graphical control field, where the parent is capable of setting a user's weekly activity availability schedule. In embodiments, each of the functional areas may be set by the administrative user to provide the user with control over only certain functions at particular times of the day within days of the week. To aid the administrative user in operating the administrative user interface 1500, a help frame 1502 may be presented. In the depicted example, the help frame 1502 contains a help video.

In embodiments, a parent (i.e. an administrative user) may have the ability to communicate with his child (i.e. a user) via a parental account. Moreover, the parent may have the ability to share media and documents with their children via their parental account. For example, once the parent is signed onto their account (either via the administrative computing facility 700 or via the computing facility 100 itself), she can do direct one or more of the following actions at one or more of her children: manually send a message to a child, wherein the message appears in a screensaver that is provided to the child by the computing facility 100; automatically send a message to a child in association with information retrieved from the Internet (for example and without limitation, the message may comprise an indication of the forecast weather and the clothes that that child should wear in association with the weather); add an action item to a calendar that is associated with the child and provided to the child by the computing facility 100, wherein the item may comprise a task, event, or automated action (for example and without limitation, the event may comprise a scheduled wake-up message, which may be provided to the child at a scheduled time as an audible alarm, such as to wake up the child. For another example and also without limitation, on a child's birthday, an automated action allow the child to have access to the messaging facility 512 or some other feature that was previously unavailable to the child); share a digital image with the child, wherein the image may be provided to the child by the computing facility 100; withdraw a digital image from the child, wherein the image may cease being provided to the child by the computing facility 100; share a digital video with the child, wherein the video may be provided to the child by the computing facility 100; withdraw a digital video from the child, wherein the vide may cease being provided to the child by the computing facility 100; provide digital content 402 to the computing facility, wherein the digital content 402 originates from a Web site.

In embodiments, the child-oriented computing system 518 may provide a parental community that may enable parents to communicate with each other on a variety of topics, as well as enabling them to rate the various software, media and content related to the computing facility 100 and/or the child-oriented computing system 518. In embodiments, the parental community may provide trusted information, such as information on proper nutrition, exercise programs, or other health and/or nutritional information directed at parents. The parental community may be implemented as a database-backed Web site, a blog, a proprietary software application, a listserv, and so forth.

In embodiments, the computing facility 100 may provide different user interfaces that vary in complexity and capability. For example, the user interface level may change automatically based upon the age of a user and/or based on the mastery of a computing skill by the user. In the preferred embodiment, the levels are implemented as follows: At the lowest level, all navigation of on-screen features of the computing facility 100 (such as and without limitation Web browsing, song selection, video selection, game selection, instant message sending, and so forth) may be done simply by pressing keys on the keyboard 104, without using the mouse 108. In order to make the system 518 easy to use, at this level there may be no editing functionality. So, for example, a user may be able to transmit a predefined instant message, but may not be able to write a new one or edit an existing one. A user may be permitted to play a game (such as may be provided by the interactive program facility 510), consume media (such as may be provided by the audiovisual facility 500, the audio facility 502, the image facility 504, and so forth). At the next level, a simple editing capability may be provided, such as and without limitation the ability to crop a picture with a simple square that can be resized and moved around. Additionally, a user may be expected to master the use of the mouse 108 with respect to movement of the mouse 108 and the use of one button on the mouse 108. However, if the mouse 108 comprises more than one button, the user may not be provided with a capability associated with those other buttons. At the highest level, an advanced photo editing capability may be present along with a video editing capability. A user may be expected to have mastered all aspects of the mouse and, for example, will be able to take advantage of right-click menus (such as those available in Windows XP and other such operating systems).

In addition to the different levels of the user interface, a simple improvement may be made to the user interface 1500, such as the elimination of a capability that may both be associated with a mainstream operating system, such as Windows XP or Mac OS X, and be associated with confusing a child. In one example, the ability to change the text associated with an icon may be eliminated. Furthermore, menus may appear only in response to a click, not just a mouse-over.

In embodiments, a parents may have access to a support button, which may provide an authorization associated with allowing the computing facility 100 to log information and current system information and to transmit said information to the administrative server application 608 of the external facility 800. In embodiments, this information may be transmitted during a call to technical support, wherein providing technical support may be associated with the external facility 800. In embodiments, a parent may provide the authorization to the computing facility 100 remotely (such as from the administrative computing facility 700) or directly (such as via the computing facility 100 itself).

In embodiments, the child-oriented computing system 518 may provide personalized access to software, media, and/or other information directed at children.

In embodiments, a user interface provided by the computing facility 100 may be graphically themed for each application or component of the service software component 532. A theme for each application of component may be grouped together into a theme set. In embodiments, the theme set for the computing facility 100 may be projected onto, provided to, or associated with a Web site, so that when the Web site is accessed it provides a theme that matches a theme in the set.

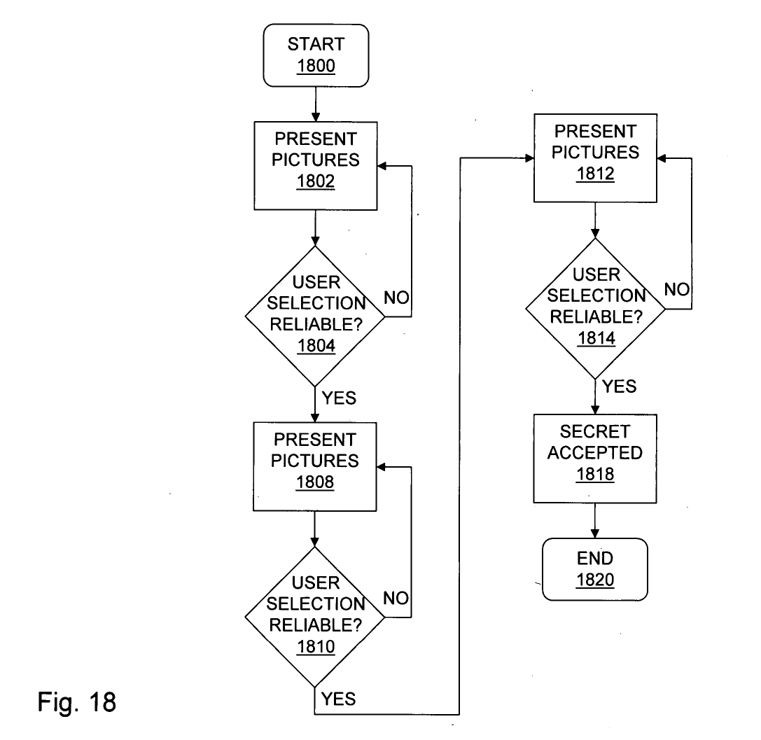

Referring now to FIG. 17, the user interface 1500 may provide an access control feature, which may present a child with a number of pictorial challenges in lieu of requiring the child to enter a password to gain access or sign on to the system 518. The child's responses to the challenges establishes whether the child knows a secret. The secret may be defined by the child and known by only the child and the child-oriented computing system 518. The secret may comprise a person, a shape, a color, some other thing that may be represented as a picture, or a sequence of the foregoing. To define the secret, the child may select a picture from a set of pictures 1700 presented to the child by the user interface 1500. Then, the user interface 1500 may present the child with a game that is directed at establishing that the child really knows the secret. In one example embodiment, the secret is a sequence including a person, a shape, and a color. The sequence may be selected by the child, who may select a picture of the person, a picture of the shape, and a picture of the color via the user interface 1500. Alternatively, the sequence may be automatically generated by the system 518 and presented to the child via the user interface 1500 as a picture of the person, a picture of the shape, and a picture of the color. Many other embodiments of the secret will be apparent.

Referring to FIG. 18 and according to the foregoing example embodiment of the secret, the game proceeds as follows: The game process begins at logical block START 1800. From there, processing flow continues to logical block PRESENT PICTURES 1802, where the child is presented with a first set of pictures 1700, each of which depicts a thing. One of the pictures depicts the person. The child utilizes the user interface 1500 to choose one of the pictures. Then, processing flow proceeds to logical block 1804, where a test is conducted to determine if the child has demonstrated that he can reliably select the picture of the person from the first set of pictures 1700. If the result of this test is negative, then processing flow returns to logical block PRESENT PICTURES 1802. Otherwise, processing flow continues to logical block PRESENT PICTURES 1808. There, the child is presented with a second set of pictures 1700. These pictures include a picture of the shape. The child utilizes the user interface 1500 to choose one of the pictures. Then, processing flow proceeds to logical block 1810, where a test is conducted to determine if the child has demonstrated that he can reliably select the shape from the second set of pictures 1700. If the result of this test is negative, then processing flow returns to logical block PRESENT PICTURES 1808. Otherwise, processing flow continues to logical block PRESENT PICTURES 1812. There, the child is presented with a third set of pictures 1700. These pictures include a picture of the color. The child utilizes the user interface 1500 to choose one of the pictures. Then, processing flow proceeds to logical block 1814, where a test is conducted to determine if the child has demonstrated that he can reliably select the shape from the third set of pictures 1700. If the result of this test is negative, then processing flow returns to logical block PRESENT PICTURES 1812. Otherwise, processing flow continues to logical block SECRET ACCEPTED 1818. There the child-oriented computing system 518 accepts the secret. Processing flow continues to logical block END 1820, where the game procedure ends. Thenceforth, the child will be presented with a set of pictures or a sequence of sets of pictures when signing on to the child-oriented computing system 518. The child will be required to provide evidence that he knows the secret by selecting pictures representative of the secret from a set of pictures or a sequence of sets of pictures, either of which are presented to the child by the user interface 1500.

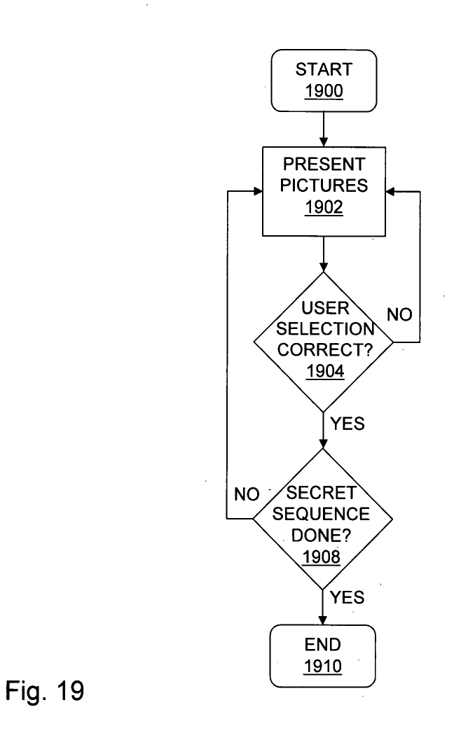

Referring to FIG. 19, a process for determining if the child knows the secret is presented. Processing flow begins at logical block START 1900. From there, processing flow continues to logical block PRESENT PICTURES 1902, where the user interface 1500 presents to the child a set of pictures 1700. These pictures include a picture of one of the secret things. The child utilizes the user interface 1500 to choose one of the pictures. Then processing flow continues to logical block 1904, where a test determines if the child has selected the secret thing that was included in the pictures. If the result of the test is negative, processing flow returns to logical block 1902. Otherwise, processing flow continues to logical block 1908, where a test is conducted to determine if the child has identified all of the secret things. If the result is negative, processing flow returns to logical block 1902, where the user interface 1500 presents to the child another set of pictures 1500, which includes a picture of one of the secret things that the child has not yet identified. Otherwise, processing flow continues to logical block end 1910, where the process terminates. It should be appreciated that the secret may be an ordered or unordered set of things, and that the process described here with reference to FIG. 19 may test the child's knowledge of these things in a particular order, when appropriate.

It will be appreciated that the various steps identified and described above may be varied, and that the order of steps may be changed to suit particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

It will be appreciated that the above processes, and steps thereof, may be realized in hardware, software, or any combination of these suitable for a particular application. The hardware may include a general purpose computer and/or dedicated computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device that may be configured to process electronic signals. It will further be appreciated that the process may be realized as computer executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software. At the same time, processing may be distributed across a camera system and/or a computer in a number of ways, or all of the functionality may be integrated into a dedicated, standalone image capture device or other hardware. All such permutations and combinations are intended to fall within the scope of the present disclosure.

It will also be appreciated that means for performing the steps associated with the processes described above may include any of the hardware and/or software described above. In another aspect, each process, including individual process steps described above and combinations thereof, may be embodied in computer executable code that, when executing on one or more computing devices, performs the steps thereof.

While the invention has been disclosed in connection with certain preferred embodiments, other embodiments will be recognized by those of ordinary skill in the art, and all such variations, modifications, and substitutions are intended to fall within the scope of this disclosure. Thus, the invention is to be understood in the broadest sense allowable by law.

1. A method of providing a non-media aspect, comprising:
accepting a specification of a non-media aspect relating to a child-oriented computing system from a first administrative user; and
providing the specification of the non-media aspect to a second administrative user.

2. A method of claim 1, wherein the non-media aspect comprises an adaptive user interface.

3. A method of claim 1, wherein the non-media aspect is a parental control.

4. A method of claim 1, wherein the second administrative user is a set of administrative users.

5. A method of claim 4, wherein the first administrative user is a set of administrative users.

6. A method of claim 5, wherein the first and second sets of administrative users are disjoint.

7. A method of claim 5, wherein the first and second sets of administrative users intersect.

8. A method of claim 5, wherein the first and second sets of administrative users are equal.

9. A method of claim 1, wherein the first administrative user is a set of administrative users.

10. A method of claim 1, wherein the first administrative user comprise a parent.

11. A method of claim 1, wherein the second administrative user comprise a parent.

12-42. (canceled)

43. A method of accessing a computer resource, comprising:
presenting a user with an interactive problem, wherein the interactive problem is associated with a solution;
receiving from the user inputs that are associated with the interactive problem, wherein the inputs lead to the solution; and
permitting access to the computer resource upon receipt of the inputs.

44. A method of claim 43, wherein the interactive problem involves a pictorial challenge.

45. A method of claim 43, wherein the interactive problem is a game.

46. A method of claim 43, wherein the computer resource is an operating system.

47. A method of claim 43, wherein the computer resource is a media resource.

48. A method of claim 47, wherein the media resource is a television.

49. A method of claim 47, wherein the media resource is a computer.

50. A method of claim 43, wherein the computer resource is a non-media resource.

51-78. (canceled)

79. A child-oriented personal computing facility, comprising:
a computing facility adapted to operate a service software component,
wherein the service software component provides a service,
wherein the service comprises a media aspect and a non-media aspect, and
wherein the non-media aspect comprises a parental control facility adapted to control the permitted usage times of the media aspect.

80. A facility of claim 79, wherein the non-media aspect further comprises a word processing facility.

81. A facility of claim 79, wherein the non-media aspect further comprises a spreadsheet facility.
